(19) United States
(12) Patent Application Publication
(10) Pub. No.: US 2010/0311296 A1
(43) Pub. Date: Dec. 9, 2010

(54) DYED CELLULOSE COMMINUTION SHEET, DYED NONWOVEN MATERIAL, AND PROCESSES FOR THEIR PRODUCTION

(76) Inventors: Brian E. Boehmer, Buchanan, TN (US); Rebecca Kate Boehmer, Buchanan, TN (US); Kathy McGee, Marion, AR (US); David Morris, Memphis, TN (US); Jim Willcutt, Hernando, MS (US); Ronald Timothy Moose, Lakeland, TN (US); Rick Bailey, Eads, TN (US); Richard Booker, Southaven, MS (US)

Correspondence Address: BAKER BOTTS L.L.P., 30 ROCKEFELLER PLAZA, 44th Floor, NEW YORK, NY, 10112-4498, US

(21) Appl. No.: 12/796,510

(22) Filed: Jun. 8, 2010

Related U.S. Application Data
(60) Provisional application No. 61/185,521, filed on Jun. 9, 2009.
(60) Provisional application No. 61/352,170, filed on Jun. 7, 2010.

(51) Int. Cl. B32B 5/02; D21H 19/36; B05D 3/12; B05D 3/02

(52) U.S. Cl. 442/71; 162/162; 427/370; 442/153; 427/392

(57) ABSTRACT

The present invention relates to a process for the dyeing of cellulosic fibers in the form of a comminution sheet to produce a dyed cellulose pulp comminution sheet with high moisture content. The dyed cellulose comminution sheet contains (a) a cellulose pulp comminution sheet having a cellulose content of from about 60 weight percent to about 99.9 weight percent cellulose based on the total weight of solids in the cellulose pulp comminution sheet, and a density of from about 0.3 g/cm³ to about 0.95 g/cm³; (b) a moisture content of from about 25 weight percent to about 55 weight percent, based on the total weight of the dyed cellulose comminution sheet, wherein the moisture content does not exceed bleed point of the comminution sheet; and (c) a dye.

### CROSS REFERENCES TO RELATED APPLICATIONS

The present application claims priority to U.S. Provisional Application No. 61/185,521, filed Jun. 9, 2009, and to U.S. Provisional Application No. 61/352,170, filed Jun. 7, 2010, the disclosures of both of which are incorporated herein by reference in their entirety.

### FIELD OF THE INVENTION

The present invention relates to a process for the dyeing of cellulosic fibers in the form of a comminution sheet to produce a dyed cellulose pulp comminution sheet with high moisture content. The present invention includes processes for the production of a dyed cellulose pulp market comminution sheet with a moisture content typical of market comminution sheets that have not been dyed or that have been produced by more traditional processes. This invention also relates to the use of the dyed cellulose pulp market comminution sheet in an airlaid process to produce dyed nonwoven material.

### BACKGROUND OF THE INVENTION

Cellulosic paper pulp is manufactured by cooking a raw material of wood chips in suitable digestive chemicals, followed by washing the fibers in water so as to form a suspension, which is passed on to a suitable dewatering device, such as a fourdrinier wire on which the fibers are dewatered and dried by subjection to a sequence of pressure and heating operations. The pulp may also be bleached in order to increase its brightness in a special bleaching step that occurs between cooking and drying steps.

One method in the state of the art for the production of a dyed cellulose pulp market comminution sheet is disclosed in WO 89/02952, where the fibers are colored by means of a coloring agent added to the fibers while they individualize in a water suspension followed by drying. U.S. Pat. Nos. 4,379,710 and 6,084,078 also disclose the addition of dye to a slurry of individual fibers, as does WO 2007/128077 and U.S. Application Publication No. 2007/0110963. Another method for the production of a finished product with colored cellulose is disclosed in WO 88/10337, where the finished egg packages made from wood pulp are sprayed with a dye. However, the '337 publication emphasizes that only the outer surface of the carton should be wet with the sprayed dye since excess penetration could compromise the integrity of the article. WO 92/13137 discloses a multilayer kraft liner where only one layer is colored. U.S. Pat. Nos. 6,270,625 and 6,733,627 disclose a method for the production of paper material with colored and uncolored areas. For the colored areas, dye is added to a slurry of individual fibers before the paper is made by means of a headbox that delivers a slurry with dye to certain areas and slurry without dye to other areas for the forming wire. U.S. Pat. No. 4,398,915 discloses a method of coloring preformed cellulosic materials, which involves chemically crosslinking a water-insoluble colorant particle to the cellulosic material, wherein the cellulosic material is impregnated with a water-insoluble colorant and subsequently bound with a chemical crosslinker. U.S. Pat. No. 5,916,416 discloses a method of producing watermark or patterns in paper or cardboard using multiple layers of fluid fibrous mixes, one of which contains a colorant.

The prior art focuses on the dyeing of individual fibers or surface dyeing. There remains a need in the art for a process for producing a feedstock in which each individual fiber is dyed, but which does not involve the addition of dye to the various slurries of individual cellulose fibers used in typical paper making processes.

### SUMMARY OF THE INVENTION

The present invention provides for a dyed cellulose comminution sheet containing

(a) a cellulose pulp comminution sheet having a cellulose content of from about 60 weight percent to about 99.9 weight percent cellulose based on the total weight of solids in the cellulose pulp comminution sheet, and a density of from about 0.3 g/cm³ to about 0.95 g/cm³;

(b) a moisture content of from about 25 weight percent to about 55 weight percent, more particularly from about 35 weight percent to about 48 weight percent, based on the total weight of the dyed cellulose comminution sheet, wherein the moisture content does not exceed bleed point of the comminution sheet; and

(c) a dye.

In specific embodiments of the dyed cellulose comminution sheet, the cellulose pulp comprises wood cellulose pulp, cotton linter pulp, chemically modified cellulose, bleached pulp, thermomechanical fibers, matrix fibers, or a combination thereof.

In particular embodiments, the density of the cellulose pulp comminution sheet is from about 0.4 g/cm³ to about 0.75 g/cm³. In specific embodiments, the dye is a direct dye, a reactive dye or a mixture thereof. In a particular embodiment, the dye is a direct dye. In another particular embodiment, the dye is a reactive dye.

In a particular embodiment of the dyed cellulose market comminution sheet, the moisture content is from about 5 weight percent to about 10 weight percent, based on the total weight of the dyed cellulose market comminution sheet, wherein the dyed cellulose market comminution sheet does not bleed, and wherein the dyed cellulose market comminution sheet has been produced by drying the dyed cellulose comminution sheet.

The present invention also provides for the processes for the production of a dyed cellulose market comminution sheet, which steps include:

(a) a cellulose pulp comminution sheet having a cellulose content of from about 60 weight percent to about 99.9 weight percent cellulose based on the total weight of the cellulose pulp sheet, and a density of from about 0.3 g/cm³ to about 0.7 g/cm³,

(b) a moisture content of from about 5 weight percent to about 10 weight percent, based on the total weight of the dyed cellulose comminution sheet, and

(c) a dye;

where the steps of the process comprise:

(i) optionally, adjusting the moisture content of a cellulose pulp comminution sheet with an initial moisture content of from about 2 weight percent to about 12 weight percent to a moisture content in the range of from about 6 weight percent to about 40 weight percent, where the weight percentages are based on the total weight of the cellulose comminution sheet,

(ii) contacting the cellulose pulp comminution sheet from (i) with aqueous dye to produce a dyed comminution sheet with a moisture content of from about 25 weight percent to about 55 weight percent, where the weight percentages are based on the total weight of the dyed cellulose comminution sheet, wherein the moisture content does not exceed the bleed point,

(iii) applying pressure to the dyed cellulose comminution sheet from (ii) to spread the dye evenly throughout the dyed cellulose comminution sheet, and

(iv) heating the dyed cellulose comminution sheet from (iii) to reduce the moisture content to an amount of from about 5 weight percent to about 10 weight percent to produce a dyed cellulose market comminution sheet, where the weight percentages are based on the total weight of the dyed cellulose market comminution sheet.

In specific embodiments of the process, the moisture content of the cellulose pulp comminution sheet is adjusted to a range of from about 15 weight percent to about 40 weight percent, where the weight percentages are based on the total weight of the cellulose comminution sheet. In a particular process, the applied roll loading pressure is from about 400 kg/linear meter to about 3,500 kg/linear meter. In another embodiment, the process produces a dyed cellulose market comminution sheet.

In a particular embodiment, the invention provides for a dyed nonwoven material having:

(a) from about 75 weight percent to about 95 weight percent of dyed cellulose fibers from a dyed cellulose market comminution sheet,

(b) from about 5 weight percent to about 25 weight percent of latex solids, where the weight percentages are based on the total weight of the dyed nonwoven material, where the dyed nonwoven material has a basis weight of from about 50 gsm to about 120 gsm. In a specific embodiment of the dyed nonwoven material, the dyed nonwoven material has a dry rub grade classification as determined by AATCC test method 8 of about 4.2 or greater. In a further embodiment, the dyed nonwoven material includes a wet strength resin. In a particular embodiment, the wet strength resin is a polyamide epichlorohydrin adduct.

The present invention also provides for a process for the production of a dyed nonwoven whose steps include:

(a) comminuting a dyed cellulose market comminution sheet to produce individualized dyed fibers,

(b) airlaying the individualized dyed fibers to form a dyed nonwoven material,

(c) treating the dyed nonwoven material from (b) with aqueous latex, and

(d) heating the nonwoven to cure the latex.

In particular embodiments, the process for the production of a dyed nonwoven includes adding a binder catalyst prior to, during, or after treating the dyed nonwoven material with latex. In other particular embodiments, the process for the production of a dyed nonwoven includes adding a wet strength resin prior to, during, or after treating the dyed nonwoven material with latex. In a specific embodiment, the wet strength resin is a polyamide epichlorohydrin adduct.

### BRIEF DESCRIPTION OF THE DRAWINGS

FIG. 1 illustrates an embodiment of the dyeing process of the present invention.

FIG. 2 illustrates an embodiment of the dyeing process of the present invention.

FIG. 3 illustrates an embodiment of the process for making an airlaid dyed nonwoven material of the present invention.

### DETAILED DESCRIPTION

The terms used in this specification generally have their ordinary meanings in the art, within the context of this invention and in the specific context where each term is used. Certain terms are defined below to provide additional guidance in describing the compositions and methods of the invention and how to make and use them.

### DEFINITIONS

The term “weight percent” is meant to refer to the quantity by weight of a compound in the material as a percentage of the weight of the material or to the quantity by weight of a constituent in the material as a percentage of the weight of the final nonwoven product.

The term “basis weight” as used herein refers to the quantity by weight of a compound over a given area. Examples of the units of measure include grams per square meter as identified by the acronym “gsm”.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, that is, the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

The term “substantive(ity)” means the adherence ability of a dye to move from a solution onto fibers in the solution. A dye that is substantive will leave the dye bath and be concentrated on the fiber in the bath. Without substantivity, most of the dye would simply remain in solution or dispersion in the bath. Dye substantivity is generally associated with the molecular structure of the dye, and often big molecules have high substantivity, while small molecules have low substantivity. Dye bath conditions, including temperature and additives such as salt influence substantivity. Substantivity is often produced in ways that differ from the final bond of the dye to the fiber.

The term “comminution sheet” means a relatively thick sheet of cellulose fibers such as those produced in various pulp mills, and is often termed herein as a “cellulose pulp comminution sheet”. This is discussed in greater detail below.

The term “dyed cellulose comminution sheet” means a “cellulose pulp comminution sheet” which has been dyed and which contains from about 25 to about 55 weight percent moisture.

The term “dyed cellulose market comminution sheet” means a “cellulose pulp comminution sheet” which has been dyed and which contains from about 5 to about 10 weight percent moisture.

The term “moisture” or “moisture content” means the weight percent H₂O or water in the material. For example, if a comminution sheet has a moisture content of 25 percent, that means that 25 weight percent of the comminution sheet is water, and 75 percent is other materials.

The term “bleed” is a characteristic of a dyed cellulosic material, such as the dyed market comminution sheet or the dyed nonwoven material for the dye to rub off when the material is rubbed or contacted, for example, in a crocking test.

The term “bleed point” is the maximum moisture content which the dyed cellulose comminution sheet can have without the dyed market comminution sheet showing bleed, and, consequently, dyed nonwoven material produced from the dyed market comminution sheet exhibiting bleed.

Cellulosic fibrous materials suitable for use in the substrate of the present invention include both softwood fibers and hardwood fibers. See M. J. Kocurek & C. F. B. Stevens, Pulp and Paper Manufacture—Vol. 1: Properties of Fibrous Raw Materials and Their Preparation for Pulping, The Joint Textbook Committee of the Paper Industry, pp. 182 (1983), which is hereby incorporated by reference in its entirety. Exemplary, though not exclusive, types of softwood pulps are derived from slash pine, jack pine, radiata pine, loblolly pine, white spruce, lodgepole pine, redwood, and Douglas fir. North American southern softwoods and northern softwoods may be used, as well as softwoods from other regions of the world. Hardwood fibers may be obtained from oaks, genus Quercus, maples, genus Acer, poplars, genus Populus, or other commonly pulped species. In general, softwood fibers are preferred due to their longer fiber length as measured by T 233 cm-95, and southern softwood fibers are most preferred due to a higher coarseness as measured by T 234 cm-84, which leads to greater intrinsic fiber strength as measured by breaking load relative to either northern softwood or hardwood fibers.

One particularly suitable cellulose fiber is bleached Kraft southern pine fibers sold under the trademark FOLEY FLUFFS®, from Buckeye Technologies Inc., Memphis, Tenn. Also preferred is cotton linter pulp, chemically modified cellulose such as cross-linked cellulose fibers and highly purified cellulose fibers, such as Buckeye HPF, each available from Buckeye Technologies Inc., Memphis, Tenn. Other suitable cellulose fibers include those derived from Esparto grass, bagasse, jute, ramie, kenaff, sisal, abaca, hemp, flax and other lignaceous and cellulosic fiber sources.

The fibrous material may be prepared from its natural state by any pulping process including chemical, mechanical, thermomechanical (TMP) and chemithermomechanical pulping (CTMP). These industrial processes are described in detail in R. G. Macdonald & J. N. Franklin, Pulp and Paper Manufacture in 3 volumes; 2^{nd} Edition, Volume 1: The Pulping of Wood, 1969; Volume 2: Control, Secondary Fiber, Structural Board, Coating, 1969, Volume 3: Papermaking and Paperboard Making, 1970, The joint Textbook Committee of the Paper Industry, and in M. J. Kocurek & C. F. B. Stevens, Pulp and Paper Manufacture, Vol. 1: Properties of Fibrous Raw Materials and Their Preparation for Pulping, The Joint Textbook Committee of the Paper Industry, p. 182 (1983), both of which are hereby incorporated by reference in their entirety. Preferably, the fibrous material is prepared by a chemical pulping process, such as a Kraft or sulfite process. The Kraft process is especially preferred. Pulp prepared from a southern softwood by a Kraft process is often called SSK. In a similar manner, southern hardwood pulp produced by a Kraft process is SHK, northern softwood pulp produced by a Kraft process is NSK and northern hardwood pulp produced by a Kraft process is NHK. Bleached pulp, which is fibers that have been delignified to very low levels of lignin, are preferred, although unbleached Kraft fibers may be preferred for some applications due to lower cost, especially if alkaline stability is not an issue. Thermomechanical cellulose fiber may be used. Desirably, the cellulose fiber for use as a matrix fiber has been derived from a source which is one or more of Southern Softwood Kraft, Northern Softwood Kraft, hardwood, eucalyptus, mechanical, recycle and rayon, but preferably Southern Softwood Kraft, Northern Softwood Kraft, or a mixture thereof, and more preferably, Southern Softwood Kraft.

Cellulose fibers from pulp mills are often processed to produce a comminution sheet. In some cases the comminution sheets are rather small, in the range of from about 0.75 m to about 1.5 m in the form of a square or rectangle, and stacked one on top of another to form bales with weights for individual bales in the range 150 kg to about 350 kg.

Another common form for the comminution sheet is that of a roll. Large rolls formed in pulp mills, called parent rolls, are generally cut to form baby rolls, which may have a width of from about 0.25 m to about 1.5 m, more commonly from about 0.25 m to about 1 m, and weights of from about 75 kg to about 750 kg. For pilot line or laboratory use, rolls with smaller widths can be produced.

A variety of pulp products have a wide range of purities, with cellulose contents ranging from about 60 weight percent to about 99.9 weight percent, based on the total weight of solids in the cellulose pulp sheet. Densities of comminution sheets may range from about 0.3 g/cm³ to about 0.7 g/cm³, more commonly from about 0.4 g/cm³ to about 0.6 g/cm³.

Moisture content of a comminution sheet may range from about 2 weight percent to about 12 weight percent, more commonly from about 5 weight percent to about 10 weight percent. If a comminution sheet is dried to a very low moisture content, such as, for example bone dry material which has been heated in an oven, and then placed in an environment, controlled or uncontrolled, the moisture content will increase until it is in equilibrium with the ambient conditions of humidity and temperature. Similar behavior is observed in materials produce from the cellulose fibers of a comminution sheet.

The caliper or thickness of a comminution sheet is commonly in the range of from about 0.1 cm to about 0.15 cm (from about 40 mil to about 60 mil, or from about 0.04 inch to about 0.06 inch).

Comminution sheets suitable for use in this invention must have sufficient wet strength to maintain their physical integrity when the moisture content of the comminution sheet is at its maximum in a continuous process, preferably, as high as about 55 percent.

### Dyed Comminution Sheet

The dyed comminution sheet of this invention consists essentially of

(a) a cellulose pulp comminution sheet having a cellulose content of from about 60 weight percent to about 99.9 weight percent cellulose based on the total weight of solids in the cellulose pulp comminution sheet, and a density of from about 0.3 g/cm³ to about 0.95 g/cm³,

(b) a moisture content of from about 25 weight percent to about 55 weight percent, based on the total weight of the dyed cellulose comminution sheet, and

(c) a dye.

A more desirable moisture content for the dyed comminution sheet is a moisture content of from about 35 weight percent to about 48 weight percent. A more desirable density for the dyed comminution sheet is a density of from about 0.4 g/cm³ to about 0.75 g/cm³.

The dyed comminution sheet must have sufficient wet strength to maintain its physical integrity when the moisture content of the comminution sheet is at its maximum in a continuous process, preferably, as high as about 55 percent.

### Dyes and Dyeing Process

Dyeing is an ancient art that has been practiced for thousands of years. The first synthetic organic dye, mauveine, was discovered in 1856. Since that time, thousands of synthetic dyes have been prepared and have quickly replaced traditional natural dyes. The choice of dye depends directly on the type of material being used. Prior art methods and practices for dyeing cellulose include five different classes of dyes, including direct, reactive, napthol, sulfur, and vat dyes.

Direct or substantive dyeing has simple application and is normally carried out in a neutral or slightly alkaline dyebath, at or near boiling point, with the addition of either sodium chloride or sodium sulfate. These dyes are generally water soluble anionic dyes that are substantive to cellulose fibers when dyed from aqueous solution in the presence of electrolytes. (see www.greatvistachemicals.com/dyes_and_pigments/direct_dye.html). Direct dyes are usually sulfonated azo compounds, but can also be stilbene or thiazole dyes. In the case of the azo direct dyes, the dyes can be further classified as monoazo, biazo, trisazo, or tetrakisazo depending on the number of azo (—N═N—) groups they contain.

Direct dyes suitable for use in dyeing cellulosic materials include, by way of example and not limitation, anionic dyes manufactured by Clariant Corporation, such as, for example, Cartasol® Yellow 6GFN liquid, Cartasol® Yellow 5GFN, Cartasol® Brilliant Yellow 5GF liquid, Cartasol® Yellow 3GSFN liquid, Cartasol® Yellow 3GF liquid, Cartasol® Yellow BGFN liquid, Cartasol® Yellow 2GFN liquid, Cartasol® Yellow FR-HP liquid, Cartasol® Yellow RFN liquid, Cartasol® Yellow RFC liquid, Cartasol® Brill Orange 2RFN liquid, Cartasol® Brill Orange 2RF granules, Cartasol® Red 2GFN liquid, Cartasol® Red 2GF powder, Cartasol® Red 3BFN liquid, Cartasol® Red 4BF liquid, Cartasol® Violet 3BF liquid, Cartasol® Brill Violet 5BFN liquid, Cartasol® Blue F3R-HP liquid, Cartasol® Blue 9809 granules, Cartasol® Blue 3RF liquid/granules, Cartasol® Blue 3R-EU liquid, Cartasol® Brill Blue RF liquid, Cartasol® Blue 2RL liquid, Cartasol® Blue GDF liquid New, Cartasol® Blue 4GF liquid, Cartasol® Turquoise FRL liquid, Cartasol® Turquoise RF liquid; cationic dyes manufactured by Clariant Corporation, such as, for example, Cartasol® Brilliant Yellow K-6G liquid, Cartasol® Yellow K-4GL liquid, Cartasol® Yellow K-GL liquid, Cartasol® Orange K-3GL liquid, Cartasol® Scarlet K-2GL liquid Cartasol® Red K-3BN liquid, Cartasol® Blue K-5R liquid, Cartasol® Blue K-RL liquid, Cartasol® Turquoise K-RL liquid/granules, Cartasol® Brown K-BL liquid; dyes distributed by Organic Dyestuffs Corporation (ORCO) of East Providence, R.I., such as, for example, ORCOLITEFAST™ Black L Ex Conc, ORCOLITEFAST™ Grey LVL 200%, ORCOLITEFAST™ Blue FFC Ex Conc (Metal Free), ORCOLITEFAST™ Blue 5GL, ORCOLITEFAST™ Blue 4GL-CF (Metal Free), ORCOLITEFAST™ Blue 7RL, ORCOLITEFAST™ Turquoise LGL, ORCOLITEFAST™ Blue FGL, ORCOLITEFAST™ Blue LUL, ORCOLITEFAST™ Blue FFRL, ORCOLITEFAST™ Navy Blue RLL 200%, ORCOLITEFAST™ Turquoise FBL, ORCOLITEFAST™ Turquoise BR, ORCOLITEFAST™ Blue 4BL 200%, ORCOLITEFAST™ Blue 3GAV, ORCOLITEFAST™ Navy NS, ORCOLITEFAST™ Navy BLC, ORCOLITEFAST™ Brown AGL, ORCOLITEFAST™ Brown GTL, ORCOLITEFAST™ Brown BRL-NB 200%, ORCOLITEFAST™ Brown BRL-MF (Metal Free), ORCOLITEFAST™ Brown BRS, ORCOLITEFAST™ Brilliant Green BL, ORCOLITEFAST™ Green 2B-NB, ORCOLITEFAST™ Grey LV-CF (Metal Free), ORCOLITEFAST™ Grey LVL, ORCOLITEFAST™ Orange LG, ORCOLITEFAST™ Orange 4GLL, ORCOLITEFAST™ Red 4BSE Ex Conc, ORCOLITEFAST™ Pink 2BL, ORCOLITEFAST™ Red 6BLL, ORCOLITEFAST™ Red 8 BLWN, ORCOLITEFAST™ Red 8 BL, ORCOLITEFAST™ Rubine 3BLL, ORCOLITEFAST™ Red BNL, ORCOLITEFAST™ Scarlet T2B, ORCOLITEFAST™ Rose FR, ORCOLITEFAST™ Red TB, ORCOLITEFAST™ Red RLS, ORCOLITEFAST™ Violet FFBL, ORCOLITEFAST™ Violet 5BLL, ORCOLITEFAST™ Rubine WLKS, ORCOLITEFAST™ Yellow 4GL 200%, ORCOLITEFAST™ Yellow RL, ORCOLITEFAST™ Brilliant Yellow 8GFF, ORCOLITEFAST™ Yellow TG, ORCOLITEFAST™ Yellow RLSW); dyes manufactured by Huntsman Corporation, such as, for example, SOLOPHENYL® BLACK FGE 600%, SOLOPHENYL® BLACK FR, SOLOPHENYL® BLUE 4GL 250%, SOLOPHENYL® BLUE FGLE 220%, SOLOPHENYL® BLUE GL 250%, SOLOPHENYL® BLUE TLE, SOLOPHENYL® BORDEAUX 3BLE, SOLOPHENYL® BROWN AGL, SOLOPHENYL® BROWN RL 130%, SOLOPHENYL® FLAVINE 7GFE 500%, SOLOPHENYL® GREEN BLE 155%, SOLOPHENYL® GREY 4GLE 300%, SOLOPHENYL® NAVY BLE 250%, SOLOPHENYL® ORANGE ARLE 220%, SOLOPHENYL® ORANGE TGL 182%, SOLOPHENYL® RED 3BL 140%, SOLOPHENYL® RED 4GE, SOLOPHENYL® RED 7BE, SOLOPHENYL® ROYAL BLUE RFE, SOLOPHENYL® SCARLET BNLE 200%, SOLOPHENYL® TURQUOISE BRLE 400%, SOLOPHENYL® VIOLET 4BLE 250%, SOLOPHENYL® YELLOW ARLE 154%, SOLOPHENYL® YELLOW GLE, and so forth.

Reactive dyes are more permanent dyes which typically form covalent ether bonds between the dye and substrate. In the case of cellulosic materials, the covalent bond is generally formed between the dye and the hydroxyl groups of the cellulose substrate in the presence of alkali. All fiber reactive dyes have substantivity for the cellulosic fibers. This class of dyes is very popular due to their fastness properties (Berger, Rebecca R., Fiber Reactive Dyes with Improved Affinity and Fixation Efficiency Thesis M.S. Textile Chemistry North Carolina State University). U.S. Pat. No. 7,038,024 discloses in depth the preparation and use of some fiber-reactive azo dyes. The main chemical classes of reactive dyes are azo, anthraquinone, and phthalocyanine

Reactive dyes suitable for use in dyeing cellulosic materials include, by way of example and not limitation, dyes manufactured by Huntsman Corporation and available in dusting powder or liquid form, such as, for example, NOVACRON® BLACK C-2R, NOVACRON® BLACK C-NN, NOVACRON® BLACK C-NN LIQ.33%, NOVACRON® BLACK LS-N-01, NOVACRON® BLACK P-GR 150%, NOVACRON® BLACK P-GR LIQ.40%, NOVACRON® BLACK P-SG, NOVACRON® BLACK P-SG LIQ.40%, NOVACRON® BLACK PE-BS, NOVACRON® BLACK PH-GR LIQ., NOVACRON® BLACK W-HF, NOVACRON® BLACK W-NN, NOVACRON® BLUE 4R, NOVACRON® BLUE C-D, NOVACRON® BLUE C-R, NOVACRON® BLUE C-R LIQ.33%, NOVACRON® BLUE FN-R, NOVACRON® BLUE H-RN, NOVACRON® BLUE LS-3R, NOVACRON® BLUE P-3R GR, NOVACRON® BLUE P-3R LIQ.40%, NOVACRON® BLUE P-6B, NOVACRON® BORDEAUX PH-R LIQ., NOVACRON® BRILLIANT BLUE FN-G, NOVACRON® BRILLIANT BLUE H-GR, NOVACRON® BRILLIANT BLUE LS-G, NOVACRON®BRILLIANT RED C-3GL, NOVACRON® BRILLIANT RED FN-3GL, NOVACRON® BRILLIANT YELLOW H-4GN, NOVACRON® BROWN NC, NOVACRON® BROWN P-6R GR, NOVACRON® BROWN P-6R LIQ.50%, NOVACRON® DARK BLUE S-GL, NOVACRON® DARK BLUE W-R, NOVACRON® DEEP RED C-D, NOVACRON® DEEP RED S-B, NOVACRON® GOLDEN YELLOW P-2RN GR S, NOVACRON® GOLDEN YELLOW P-2RN LIQ.33%, NOVACRON® GREY NC, NOVACRON® LEMON S-3G, NOVACRON® NAVY C-BN, NOVACRON® NAVY C-BN LIQ.25%, NOVACRON® NAVY C-R, NOVACRON® NAVY FN-BN, NOVACRON® NAVY H-2G, NOVACRON® NAVY LS-G, NOVACRON® NAVY P-2R, NOVACRON® NAVY P-2R LIQ.33%, NOVACRON® NAVY PH-R LIQ., NOVACRON® NAVY S-G; reactive dyes comprised of vinyl sulfone and monoochlorotriazine linking groups such as those distributed by Organic Dyestuffs Corporation (ORCO) of East Providence, R.I., such as, for example, Orco Reactive Black BFT™-Special, Orco Reactive Black BF™-Special 40% Liquid, Orco Reactive Navy Blue BF™-2 GB, Orco Reactive Navy Blue BF™-2RB, Orco Reactive Blue BF™-BRF, Orco Reactive Navy Blue BF™-FBN, Orco Reactive Orange BF™-2Rx, Orco Reactive Red BF™-6BN, Orco Reactive Red BF™-6BN 25% Liquid, Orco Reactive Red BF™-4BL, Orco Reactive Golden Yellow BF™-2GR, Orco Reactive Yellow BF™-2GR 25% Liquid, Orco Reactive Yellow BF™-3GN, Orco Reactive Golden Yellow BF™-4GR; reactive dyes comprised of vinyl sulfone linking groups such as those distributed by Organic Dyestuffs Corporation (ORCO) of East Providence, R.I., such as, for example, ORCO® REACTIVE Black GR, ORCO® REACTIVE Black GR 25% Liquid, ORCO® REACTIVE Black RB, ORCO® REACTIVE Black RB Liquid 25%, ORCO® REACTIVE Black RRL, ORCO® REACTIVE Blue RW Special, ORCO® REACTIVE Turquoise RP, ORCO® REACTIVE Turquoise RP Liquid 33%, ORCO® REACTIVE Navy Blue RGB, ORCO® REACTIVE Blue RGB 25% Liquid, ORCO® REACTIVE Brown RGR, ORCO® REACTIVE Orange 3RA, ORCO® REACTIVE Orange 3RA Liquid 25%, ORCO® REACTIVE Orange R3G, ORCO® REACTIVE Orange RFR, ORCO® REACTIVE Brilliant Red RBR, ORCO® REACTIVE Bordeaux RB, ORCO® REACTIVE Brilliant Red RF3B, ORCO® REACTIVE Red RB, ORCO® REACTIVE Red R3BS, ORCO® REACTIVE Violet R5R 120%, ORCO® REACTIVE Violet R4B, ORCO® REACTIVE Yellow RGR 110%, ORCO® REACTIVE Golden Yellow RGA, ORCO® REACTIVE Brilliant Yellow RGL, ORCO® REACTIVE Brilliant Yellow R4GL 150%; hot dyeing reactive dyes for cellulosic fibers such as those distributed by DyStar Textilfarben GmbH & Co., Germany, such as, for example, Procion® Yellow H-E4R, Procion® Yellow H-E6G, Procion® Orange H-ER, Procion® Red H-E3B, Procion® Red H-E7B, Procion® Blue H-EGN 125%, Procion® Blue H-ERD, Procion® Navy H-ER 150%, and so forth.

The diazo- or Naphthol class of dyes is applied to cellulosic fibers by treating the fibers with both diazoic and coupling components which interact to form an insoluble azoic dye. Typically, the fiber is first soaked in a cold aqueous caustic soda solution of a Naphthol. The fibers are permitted to adsorb the phenolic compound, after which they are squeezed, dried, and soaked in a solution of a diazo compound of an amine. It is at this stage that the coupling takes place in the fiber, resulting in the formation of an insoluble dye. SEE The Physical Chemistry of Dying. by Thomas Vickerstaff, published for imperial Chemical Industries Ltd. by Oliver and Boyd, London and Edinburgh, and Interscience, New York, second ed., 1954. Azoic dyes have excellent wet fastness properties.

This class of dyes include, by way of example and not limitation, dyes manufactured by Shanghai Epochem Co., Ltd. of Shanghai China, such as, for example, dyes known by product names as Napthol AS, Napthol AS-BO, Napthol AS-G, Napthol AS-SW, Napthol AS-E, Napthol AS-RL, Napthol AS-SG, Napthol AS-PH, Napthol AS-BS, Napthol AS-D, Napthol AS-OL, Napthol AS-CA, Napthol AS-VL, Bordeaux GP Base, Orange GC Base, Fast Garnet B Base, Red B Base, Red GL Base, Red RC Base, Fast Scarlet G Base, Scarlet RC Base, Red RL Base, Fast Yellow GC Base, Black B Base, and so forth.

Sulfur dyes are two-part dyes that are traditionally used to impart dark colors to cellulosic fibers. They are generally applied to cellulose from an alkaline reducing bath using sodium sulfide as the reducing agent. Sulfur dyes suitable for use in dyeing cellulosic materials include, by way of example and not limitation, dyes manufactured by Clariant Corporation, such as, for example, DIRESUL® Yellow RDT-E Liquid, Diresul® Orange RDT-GR Liquid, Diresul® Orange RDT-2R Liquid, Diresul® Yellow-Brown RDT-G Liquid, Diresul® Brown RDT-GN Liquid, Diresul® Brown RDT-R Liquid, Diresul® Bordeaux RDT-6R Liquid, Diresul® Olive RDT-B Liquid, Diresul 1 Brilliant Green RDT-GL Liquid, Diresul® Blue RDT-2G Liquid,

Diresul® Blue RDT-B Liquid, Diresul® Blue RDT-3R Liquid, Diresul® Black RDT-RLLiquid, Diresul® Black RDT Liquid; dyes such as Orcosol® Black B4G manufactured by Organic Dyestuffs Corporation (ORCO), and so forth.

Vat dyes, which were traditionally based on one of the oldest known dyes, indigo, are now characterized by the quinone grouping that they contain. They are insoluble in water, but can be dissolved by reducing their carbonyl groups in an alkaline bath with sodium hydrosulfite to a leuco-compound, which is then soluble in caustic soda. Under the correct conditions, cellulosic fibers can rapidly adsorb leuco-dyes. SEE The Physical Chemistry of Dying. by Thomas Vickerstaff, published for Imperial Chemical Industries Ltd. by Oliver and Boyd, London and Edinburgh, and Interscience, New York, second ed., 1954. The major chemical classes of vat dyes are anthraquinone and indigoid. SEE Kirk-Othmer Encyclopedia of Chemical Technology Volume 8, 3rd Edition by Kirk-Othmer, A Wiley-Interscience Publication, John Wiley and Sons, New York, Chichester, Brisbane, Toronto. 1979. Vat dyes are sold as powders or pastes which can be diluted in water to form dispersions.

Vat dyes suitable for use in dyeing cellulosic materials include, by way of example and not limitation, the ZYMO-FAST series of vat dyes manufactured by Aljo® Mfg. Co. (New York, N.Y.), such as, for example, Yellow #575, Yellow 5G #3140, Brilliant Yellow #2320, Pure Yellow #2623, Supra Yellow #2299, Golden Yellow #1370, Orange #620, Bright Orange #863, Golden Orange #1409, Bright Pink #860, Red #780, Red #940, Synthetic Indigo #919, Brilliant Indigo #2120, Sky Blue #686, Bright Blue #2432, and solubilized vat dyes manufactured by Karan Dyestuffs Industries of Gujarat, India, such as, for example, JINTEXSOL Golden Yellow IGK, JINTEXSOL Golden Yellow IRK, JINTEXSOL Blue 04B, JINTEXSOL Brown IRRD, JINTEXSOL Brown IBR, JINTEXSOL Green IB, JINTEXSOL Grey IBL, JINTEXSOL Pink IR, JINTEXSOL Orange HR, JINTEXSOL Violet 14R, JINTEXSOL Red Violet RF, JINTEXSOL Blue 4B, and so forth.

Of the aforementioned classes of cellulosic dyes, the two most important for the practice of the present invention are the direct and reactive dyes. It is a known practice to prepare compositions for the direct and reactive dyeing of cellulose fibers in a slurry form. The present invention discloses a technique whereby cellulose fibers in sheeted form can be effectively dyed.

A dyed cellulose market comminution sheet can be produced from the dyed cellulose comminution sheet by reducing the moisture content to an amount of from about 5 weight percent to about 10 weight percent, where the weight percentages are based on the total weight of the dyed cellulose market comminution sheet.

The dyed cellulose comminution sheet and the dyed cellulose market comminution sheet are produced by a process of this invention, which include the following steps:

(i) optionally, adjusting the moisture content of a cellulose pulp comminution sheet with an initial moisture content of from about 2 weight percent to about 12 weight percent to a moisture content in the range of from about 6 weight percent to about 40 weight percent, where the weight percentages are based on the total weight of the cellulose pulp comminution sheet,

(ii) contacting the cellulose pulp comminution sheet from (i) with aqueous dye to produce a dyed comminution sheet with a moisture content of from about 25 weight percent to about 55 weight percent, where the weight percentages are based on the total weight of the dyed cellulose comminution sheet, wherein the moisture content does not exceed the bleed point,

(iii) applying pressure to the dyed cellulose comminution sheet from (ii) to spread the dye evenly throughout the dyed cellulose comminution sheet, and

(iv) heating the dyed cellulose comminution sheet from (iii) to reduce the moisture content to an amount of from about 5 weight percent to about 10 weight percent to produce a dyed cellulose market comminution sheet, where the weight percentages are based on the total weight of the dyed cellulose market comminution sheet. Preferably, this is a continuous process.

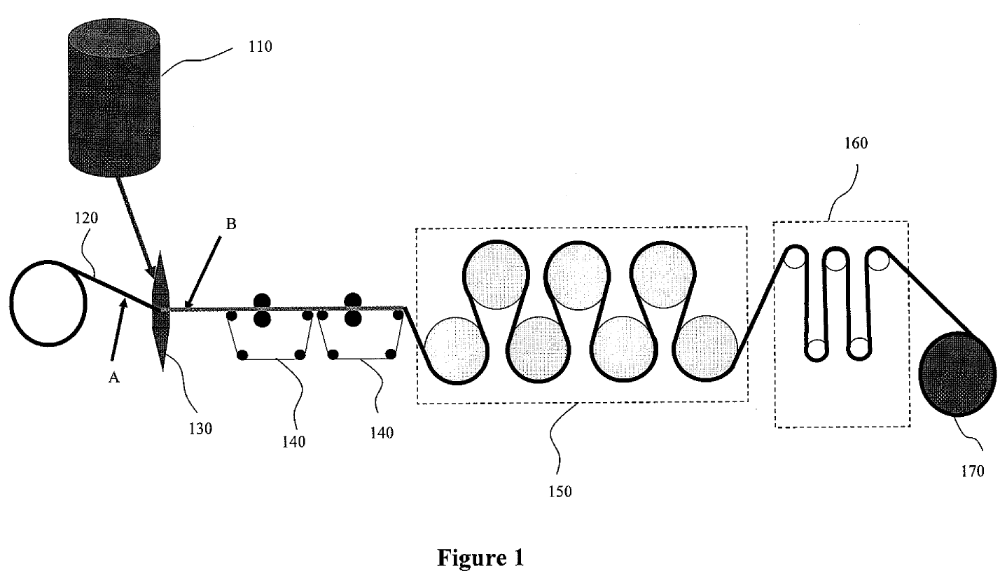

FIG. 1 illustrates an exemplary embodiment of the dyeing process of the present invention. One or more dyes are provided as an aqueous solution in a dye tank 110. The dye solution is delivered to a dye applicator 130 to apply the dye to a cellulose pulp comminution sheet 120 passing through the applicator. The dyed cellulose pulp comminution sheet is then passed through one or more presses 140 to distribute the dye evenly throughout the dyed cellulose pulp comminution sheet. Thereafter, the dyed cellulose pulp comminution sheet is heated in a dryer 150, which can include, for example, a series of steam heated rolls as shown, to reach a target moisture content. The dried dyed cellulose pulp comminution sheet, also known as the dyed cellulose pulp market comminution sheet, is then collected on a rewind roller 170, optionally through an accumulator 160, which serves as a temporary holder of the dried dyed cellulose pulp comminution sheet during the period of replacement of the roll of dried dyed cellulose pulp comminution sheet on the rewind roller 170.

In a particular embodiment of the invention, the moisture content of the cellulose pulp comminution sheet is adjusted to a moisture content in the range of from about 15 weight percent to about 40 weight percent before being dyed, for example, at point A in FIG. 1, where the weight percentages are based on the total weight of the cellulose pulp comminution sheet.

The moisture content can be adjusted by various methods known in the art, such as, for example, by spraying the cellulose pulp comminution sheet with water. Application of the dye to a cellulose pulp comminution sheet with somewhat higher moisture content than it would have under ambient conditions facilitates a more even distribution of dye in the cellulose pulp comminution sheet.

A dye can be applied to the cellulose pulp comminution sheet by various methods known in the art, such as, for example, spraying the cellulose pulp comminution sheet with an aqueous dye solution, by passing the cellulose pulp comminution sheet through a puddle press containing an aqueous dye solution, application of the dye solution to a roller which then transfers it to the comminution sheet, or a weir process. A weir process involves placing a reservoir above the pulp comminution sheet set up as an overflow spillway. When the crest of the weir is level, the amount of fluid released over the crest of the weir can be adjusted for rate. Accordingly, the dye applicator 130 shown in FIG. 1 can be a sprayer, a roller, one or more manifolds including a hollow cylinder having a series of small holes on the cylinder wall, among others. After exiting the dye applicator, for example, at point B in FIG. 1, the dyed comminution sheet can have a moisture content of from about 25 weight percent to about 55 weight percent, and more desirably a moisture content of from about 35 weight percent to about 48 weight percent, where the weight percentages are based on the total weight of the dyed cellulose comminution sheet.

The application of dye across the sheet desirably is even. However, this is not critical, as areas of minor unevenness in the application of the dye are inevitable. In a major use of the dyed cellulose market comminution sheet, the production of dyed nonwoven material, the dyed cellulose market comminution sheet will be comminuted into individual fibers, as for example, in a hammermill, the individual fibers will be air entrained, and deposited on a forming wire. There will be considerable mixing in this process, so that fully dyed fibers are mixed with partially dyed fibers. For example, if the objective is to make red nonwoven material, and comminution sheet has areas that are fully red, and, due to unevenness of application of dye in the production of the dyed cellulose market comminution sheet, some areas where the fibers are less red or even pink, it will not be noticeable in the final product.

The moisture content of the dyed cellulose comminution sheet must not exceed the bleed point. If the moisture content does exceed the bleed point, it will be impossible to adjust the characteristics of the dyed cellulose comminution sheet to correct the problem. Subsequent application of increased pressure will result in crushing the dyed cellulose comminution sheet before the excess moisture can be removed. Additionally, when the dyed cellulose comminution sheet is heated to produce the dyed cellulose market comminution sheet, the problem can not be corrected. The result will be that nonwoven materials produced from the dyed cellulose market comminution sheet will bleed, that is, for example, a colored napkin in use may transfer dye to the hands and face of someone using the napkin while dining Therefore, the specified moisture content is an important feature to maintain in order to avoid the drawbacks such as bleeding in the present invention.

After the cellulose comminution sheet is dyed, the sheet is subjected to pressure, which can be accomplished in various ways, such as, for example, by passing the dyed cellulose comminution sheet through a pneumatic press roll. The applied roll loading is from about 400 kg/linear meter to about 3,500 kg/linear meter, preferably from about 700 kg/linear meter to about 2,800 kg/linear meter. The application of pressure to the dyed cellulose comminution sheet with its relatively high moisture content containing the dye facilitates distribution of the dye throughout the dyed cellulose comminution sheet, so that essentially every fiber is contacted by aqueous dye. The applied roll loading must not be so high that it crushes the dyed cellulose comminution sheet, and thereby compromises its integrity.

The dyed cellulose comminution sheet is then heated to remove moisture, the result being the formation of a dyed market comminution sheet with a moisture content of from about 5 weight percent to about 10 weight percent. Heat may be applied by any convenient method, such as, for example, heated steam rolls as shown in FIG. 1.

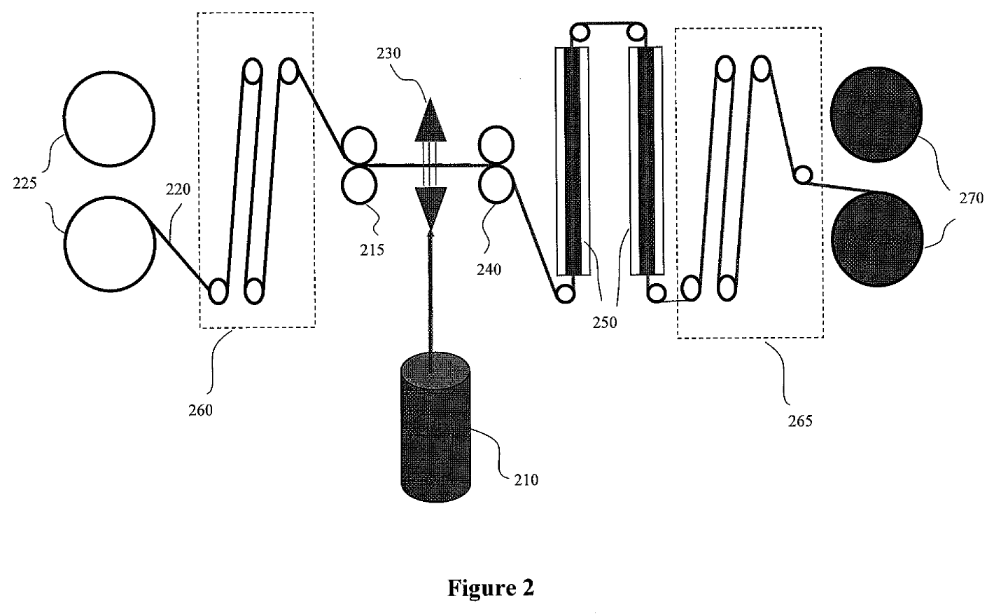

FIG. 2 illustrates an alternative embodiment of the dyeing process of the present invention. One or more dyes are provided as an aqueous solution in a dye tank 210. The dye solution is delivered to a dye applicator 230 to apply the dye to a cellulose pulp comminution sheet 220 passing through the applicator. The cellulose pulp comminution sheet 220 can be provided by a plurality of supplier rolls 225, and passed through an accumulator 260 to facilitate the continuous operation of the dyeing process. Before applying the dye solution using the dye applicator 230, the tension of the cellulose pulp comminution sheet can be adjusted by a pair of rollers 215. The dyed cellulose pulp comminution sheet is then passed through one or more presses 240. Thereafter, the dyed cellulose pulp comminution sheet is heated in a dryer 250, which can be an infrared heater, microwave heater, etc., to reach a target moisture content. The dried dyed cellulose pulp comminution sheet, also known as the dyed cellulose pulp market comminution sheet, is then collected on a dual rewind 270, optionally through an accumulator 265.

### Conversion of Dyed Cellulose Market Comminution Sheet into Dyed Nonwoven Material

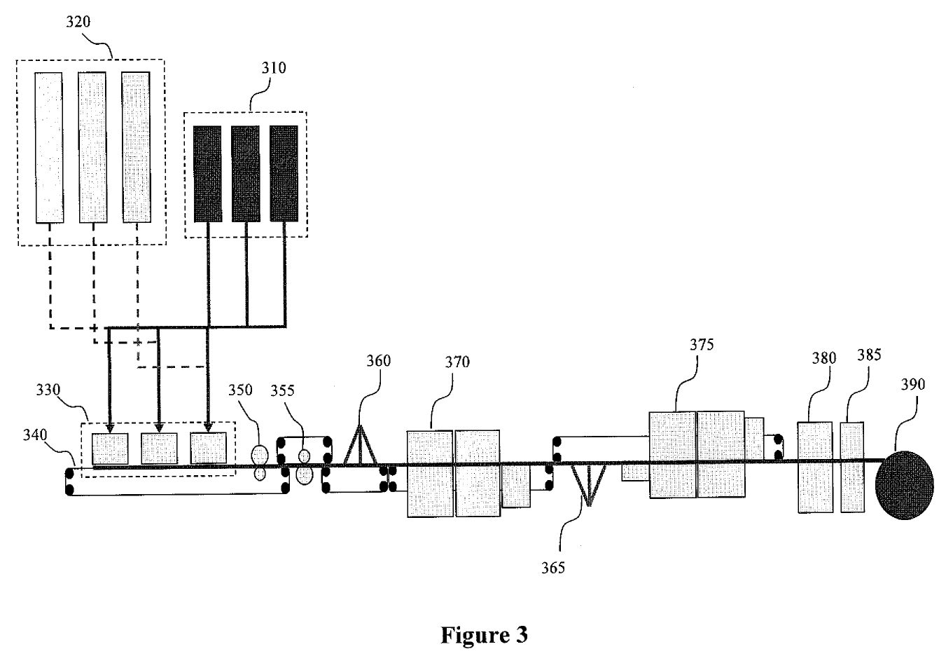

In a preferred process suitable for commercial production, the dyed nonwoven material of this invention is produced using the dyed market comminution sheet of this invention in a continuous airlaid web. FIG. 3 illustrates an exemplary embodiment of the process for making an airlaid dyed nonwoven material of the present invention. The dyed market comminution sheet is first disintegrated or defiberized by one or more hammermills 310 to provide individualized fibers. The individualized fibers are then air conveyed to one or more forming heads 330 on the airlaid web-forming machine, which deposit the air-entrained fibers onto a moving forming wire 340. Optionally, other fibrous materials for making the nonwoven material, for example, synthetic fibers, including bicomponent synthetic fibers commonly used in the industry, can be provided in one or more feed towers 320, mixed with the individualized cellulose fibers in the one or more forming heads 330, and deposited on the forming wire 340.

After passing through a compactor roll 350 and optionally through an emboss roll 355, the airlaid material is treated on one side with a latex binder or a mixture of latex binders in a binder application station 360. Various binder catalysts can be applied along with the latex binder(s). Alternatively, various wet strength resins can be applied along with the latex binders using the binder application station 360. The latex binder(s), the binder catalyst(s), and/or wet strength resins can be applied by spraying, or other commonly used methods such as foaming, doctor blade or transfer from a roller.

The airlaid web is then optionally transferred from the forming wire to a calendar or other densification stage to densify the web, if necessary, to increase its strength and control web thickness. To bond the fibers of the web, the web is then passed through an oven 370 to heat the web at an appropriate temperature for a sufficient duration of time to cure the binder materials. The oven can preferably be a conventional through-air oven, or be operated as a convection oven, but may achieve the necessary heating by infrared or microwave irradiation.

The web exiting from the oven 370 can be further treated by a latex binder(s) on the other side using a second binder application station 365, which can also apply suitable binder catalyst(s) and/or wet strength resins with the latex binder(s). Such a treated web is then passed through a second oven 375 to cure the newly applied binder materials. Afterwards, the cured web is passed through a post oven emboss 380, and a finalization device 385 which applies one or more dye fixative(s), and/or water to adjust the moisture content. The web is then collected by a rewind roller 390.

It is understood that the dyed nonwoven material can be prepared by different variations of the above-illustrated process. For example, the airlaid web can be passed through a binder application station which applies latex binders and other additives on both sides of the air-laid web, and is then fed to an oven. In an another example, the binder catalyst(s) and/or the wet strength resin(s) can be added prior to or after the application of latex using separate applicators. In a further example, one or more additional ovens can be used for curing the web.

A number of manufacturers make airlaid web forming machines suitable for use in this invention, including Dan-Webforming International A/S (Denmark), M&J Airlaid Products A/S (Denmark), Rando Machine Corporation (Macedon, N.Y.), which is described in U.S. Pat. No. 3,972,092, Margasa Textile Machinery (Cerdanyola del Vallès, Spain), and DOA International of Wels (Austria). While these many forming machines differ in how the fiber is opened and air-conveyed to the forming wire, they all are capable of producing the webs of this invention. The Dan-Web forming heads include rotating or agitated perforated drums, which serve to maintain fiber separation until the fibers are pulled by vacuum onto a foraminous forming conveyor or forming wire. In the M&J machine, the forming head is basically a rotary agitator above a screen. The rotary agitator may comprise a series or cluster of rotating propellers or fan blades. Where defined layers are desired, separate forming heads may be used for each type of fiber or mixture of fibers.

### Latex Binders

Various latex binders are suitable for use in the nonwoven material of this invention, such as, for example, ethylene vinyl acetate copolymers, also referred to as ethyl vinyl acetate copolymers, such as AirFlex 124® offered by Air Products (Allentown, Pa.). AirFlex 124® is used with 10 percent solids and 0.75 percent by weight AEROSOL® OT which is an anionic surfactant offered by Cytec Industries (West Paterson, N.J.). Preferred ethylene vinyl acetate copolymers are Vinnapas from Wachker and Vinamul from Celanese. Other classes of emulsion polymer binders such as styrene-butadiene and acrylic binders may also be used. Binders AIRFLEX® 124 and 192 from Air Products (Allentown, Pa.), optionally having an opacifier and whitener, such as, for example, titanium dioxide, dispersed in the emulsion may be used. Other classes of emulsion polymer binders such as styrene-butadiene, acrylic, and carboxylated styrene butadiene acrylonitrile (SBAN) may also be used. A carboxylated SBAN is available as product 68957-80 from Dow Reichhold Specialty Latex LLC of Research Triangle Park, N.C. The Dow Chemical Company (Midland, Mich.) is a source of a wide variety of suitable latex binders, such as, for example, Modified Styrene Butadiene (S/B) Latexes CP 615NA and CP 692NA, and Modified Styrene Acrylate (S/A) Latexes, such as, for example, CP6810NA. A wide variety of suitable latices are discussed in Emulsion Polymers, Mohamed S. El-Aasser, Carrington D. Smith, I. Meisel, S. Spiegel, C. S. Kniep, ISBN: 3-527-30134-8, from the 217th American Chemical Society Meeting in Anaheim, Calif. in March 1999, and in Emulsion Polymerization and Emulsion Polymers, Peter A. Lovell, Mohamed S. El-Aasser, ISBN: 0-471-96746-7, published by Jossey-Bass, Wiley. Also useful are various acrylic, styrene-acrylic and vinyl acrylic latices from Specialty Polymers, Inc., 869 Old Richburg Rd., Chester, S.C. 26706. Also useful are Rhoplex™ and Primal™ acrylate emulsion polymers from Rohm and Haas. In the present invention, latex solids are present in amounts from about 5 weight percent to about 20 weight percent.

### Binder Catalysts

Catalysts can be added to binders to improve curing and cross-link formation. Common binder catalysts suitable for the present invention include mineral acids, also known as inorganic acids. These acids may include, by way of example and not limitation, hydrochloric acid, sulfuric acid, nitric acid, phosphoric acid, boric acid, hydrofluoric acid, hydrobromic acid, sodium bisulfate, and hydrogen chloride. Additionally, Lewis acids can be added as catalysts. These acids may include, for example, metal cations. A triethanolamine titanium complex, such as, for example, DuPont™ Tyzor® may act as a Lewis acid catalyst. Finally, organic acids can be added as catalysts. These acids may include, by way of example and not limitation, lactic acid, citric acid, formic acid, acetic acid, oxalic acid, dichloroacetic acid, paratoluenesulfonic acid, sorbic acid, malic acid, ethylenediaminetetracetic acid, and uric acid.

In addition, chemicals that function as heat sensitizers can be added as binder catalysts. Such chemicals might include, by way of example and not limitation, functional siloxane compounds, such as siloxane oxyalkylene block copolymers and organopolysiloxanes. Additional chemicals used as heat sensitizers include emulsified salts, such as zinc salts, for example, zinc chloride; ammonium salts, for example, ammonium chloride; and multivalent salts, for example, aluminum sulfate. Specific examples of applicable heat-sensitizers and their use thereof for the heat sensitization of latices are described in U.S. Pat. Nos. 3,255,140; 3,255,141; 3,483,240; 3,484,394; and 4,176,108.

### Wet Strength Resins

Upon the formation of a cellulosic material, the fibers are mainly held together by hydrogen bonds. The hydrogen bonds are dependent on physical contact between the fibers and can be broken by wetting the fibers. The residual wet tensile strength of wet cellulosic material is less than ten percent of its initial dry tensile strength.

Various techniques, such as refining the pulp and wet pressing on the paper machine, can be used to mechanically reduce the strength loss of the cellulosic material upon wetting. For example, wet strength chemicals can be used to improve the wet strength of a cellulosic sheet, which can retain as much as fifty percent of the original dry strength of the sheet. Wet strength chemicals improve the tensile properties of the cellulosic material both in wet and dry state by cross-linking the cellulose fibers with covalent bonds that do not break upon wetting.

Polymeric wet strength resins, a type of wet strength chemical, are commonly used in the pulp and paper industry to increase the wet and dry tensile strength of paper. Resins suitable for use in increasing the tensile strength of cellulosic materials include, by way of example and not limitation, polyamide epichlorohydrin adducts (PAE) manufactured by Ashland Hercules Water Technologies, such as, for example, Kymene® 557H, Kymene® 821, Kymene® 920A, and Kymene® G3 XG1, anionic polyacrylamide (APAM) manufactured by Ashland Hercules Water Technologies, such as, for example, Hercobond® 2000, glyoxalated polyacrylamide (GPAM) manufactured by Ashland Hercules Water Technologies, such as, for example, Hercobond® 1000, and Hercobond® 1194, modified polyamine manufactured by Ashland Hercules Water Technologies, such as, for example, Hercobond® 6350, cationic and amphoteric polyacrylamide manufactured by Ashland Hercules Water Technologies, such as, for example, Hercobond® 1200, Hercobond® 1205, Hercobond® 2264, carboxymethyl cellulose (CMC) manufactured by Ashland Hercules Water Technologies, anionic and cationic guar manufactured by Ashland Hercules Water Technologies, modified polyacrylamide manufactured by Kemira, such as, for example, Parez® 745, Parez® 631 NC, and Parez® 920, water soluble cationic polyacrylamide manufactured by Kemira, such as, for example, Parez® 930, polyamide manufactured by Kemira, such as, for example, Parez® 617C, Parez® 625, and Parez® 628, polyamide-polyamine manufactured by Kemira, such as, for example, Parez® 617-2 B, melamine-formaldehyde manufactured by Kemira, such as, for example, Parez 607L, polyacrylamide manufactured by Georgia-Pacific, such as, for example, Ambond® 1500 and Ambond® 1505, modified polyacrylamide manufactured by Georgia-Pacific, such as, for example, Ambond® 1510, polyamide manufactured by Georgia-Pacific, such as, for example, Amres® 135, Amres® 25-HP, Amres® 652, Amres® 8855, Amres® 8870, and Amres® HP-100, low AOX polyamide manufactured by Georgia-Pacific, such as, for example, Amres® MOC-3025 and Amres® MOC-3066, polyvinylamine manufactured by BASF, such as, for example Lupamin® 9095, and dialdehyde starch manufactured by Monomer-Polymer and Dajac Labs.

It is known in the art that various wet strength resins, for example, various cationic amine polymer-epichlorohydrin adduct resins marketed under the tradename Kymene®, can be used as fixatives to improve color fastness. These resins have been used in the wet-laid nonwoven field for decades for improving the wet strength of wet-laid nonwoven materials, but have not been known to be used in the air-laid nonwoven industry for affixing dyes. In the present invention, when such wet strength resins are applied together with the latex binders on the dyed airlaid web, the color fastness of the end nonwoven material was dramatically improved, such that no additional dye fixatives need to be applied by the finalization device 385. Depending on the types and the amounts of the dye used, the wet strength resin can be added in a basis weight range of from about 0.1 gsm to about 8 gsm on the dyed nonwoven material, and preferably in a basis weight range of from about 0.5 to about 4 gsm on the dyed nonwoven material.

### Dye Fixatives

Dye fixatives can be used at the end of the dyed nonwoven material manufacturing process to permanently or substantially permanently affix the applied dye to the fibers of the nonwoven material. Traditional dyeing processes typically remove a majority of excess dye by washing it away. The process described in the present application does not allow for excess dye to be washed off because the fibers are dyed and processed while still in cellulose comminution sheet form. As a part of this process, the present application describes several means to limit excess dye bleed including individually or as a combination, minimizing excess dye applied to the cellulose comminution sheet, applying a latex binder to coat the individualized fibers within the dyed airlaid substrate, adding a wet strength resin to the dyed airlaid substrate, as well as adding a dye fixative to the dyed airlaid substrate by means of a finalization bar. There are a wide variety of chemicals used for dye fixation depending upon the substrate being dyed and the particular dye being used. A dye fixative may be described as a chemical that provides protection against dye bleeding, fading, and transfer. Dye fixatives may also be used to alter the final color of the material or as a reserving agent.

There are three primary types of fixatives: inorganics such as aluminum sulfate and polyaluminum chloride based chemicals; organics such as modified cationic starch; and synthetics such as polyamine, polyethylenimine, dicyandiamide, epichlorohydrin, polydiallyldimethylammonium chloride (polydadmac), and polyvinylamine.

Many dye fixatives are cationic in nature and may include, by way of example and not limitation, cationic complexing agents manufactured by Huntsman Corporation, such as, for example, ALBAFIX® ECO, or organic cationic polyelectrolytes manufactured by Huntsman Corporation, such as, for example, ALBAFIX® R. For some uses, a dye leveling agent such as an alkyl amine polyglycol ether sulfate manufactured by Huntsman Corporation, such as, for example, ALBEGAL® A, may be sufficient. Even a pad dyeing assistant comprised of a polymer mixture manufactured by Huntsman Corporation, such as, for example, ALBAFIX® E, might be appropriate. A high molecular weight cationic polydadmac fixative manufactured by Huntsman Corporation, such as, for example, ALCOFIX® 111, could also be used.

Additionally, an epichlorohydrin dimethylamino propyleneamine copolymer manufactured by Clariant Corporation, such as, for example, Cartafix® NJC liquid, or a cationic aliphatic polyamine derivative manufactured by Clariant Corporation, such as, for example, Cartafix® TSF liquid or Cartafix® NTC liquid, might be used. Other polyamine-epichlorohydrin (branched) fixatives manufactured by the Clariant Corporation, such as, for example, Cartafix® CB or Cartafix® DPR, or polyamine-epichlorohydrin (linear) fixatives manufactured by the Clariant Corporation, such as, for example, Cartafix® F, could also be used. Finally an organic polymer, such as that manufactured by Clariant Corporation, for example, Cartafix® VXZ liquid, a cationic resinous compound such as a guanidine, cyano-, polymer with 1,2-ethanediamine, N-(2-aminoethyl)-, hydrochloride salt manufactured by Clariant Corporation, such as, for example, Cartafix® SWE liquid, or a dicyandiamide-formaldehyde manufactured by Clariant Corporation, such as, for example, Cartafix® W, might be used.

Some natural dyes require mordants for dye fixation. Mordants are substances used to set dyes on fabrics or tissues by forming coordination complexes with the dye which then attaches to the fabric or tissue. Common mordants included tannic acid, sumac, gall nuts, bark extracts, alum, urine, chrome alum, oleic acid, stearic acid, Turkey red oil, sodium chloride, and certain salts of aluminum, chromium, copper, iron, iodine, potassium, sodium, and tin. Other chemical assistants which may improve dye fixation for natural dyes include oils and sulfonate oils, soaps, fats, and higher acids.

Depending on the types and the amounts of the dye used, the dye fixative can be added in an amount of from about 0.1 weight percent to about 10 weight percent of the dyed nonwoven material, and preferably in an amount of from about 0.05 weight percent to about 3 weight percent of the dyed nonwoven material.

### Dyed Nonwoven Material

The dyed nonwoven material of this invention, which is produced from the dyed market comminution sheet of this invention, typically has one ply with a basis weight of from about 40 gsm to about 120 gsm, more typically from about 50 gsm to about 80 gsm. The dry tensile strength as measured by EDANA Method WSP 110.4 may range from about 16 N/5 cm to about 21 N/5 cm in the machine direction and from about 13 N/5 cm to about 18 N/5 cm in the cross direction. Elongation as measured by EDANA Method WSP 110.4 may range from about 10 percent to about 15 percent in the machine direction and from about 12 to about 18 in the cross direction. The wet tensile strength as measured by EDANA Method WSP 110.4 may range from about 8 N/5 cm to about 12 N/5 cm in the machine direction and from about 13 N/5 cm to about 18 N/5 cm in the cross direction. Absorption as measured by EDANA Method WSP 10.1 may range from about 300 g/m² to about 450 g/m². The dyed nonwoven material has a dry rub grade classification as determined by AATCC test method 8 of about 4.2 or greater.

### EXPERIMENTAL

The following examples are merely illustrative of the present invention and they should not be considered as limiting the scope of the invention in any way.

Materials used in the experimental examples include the following:

FOLEY FLUFFS® bleached Southern softwood Kraft in the form of a cellulose pulp comminution sheet manufactured by an affiliate of Buckeye Technologies Inc. (Memphis, Tenn.). FOLEY FLUFFS® brand fibers are fabricated from cellulosic materials, primarily wood pulp from slash pine.

DUR-O-SET® Elite 22 is an ethylene vinyl acetate copolymer manufactured by Celanese Ltd. (Dallas, Tex.).

DUR-O-SET® Elite Plus 25-299a is a cationic, vinyl acetate/ethylene (VAE) copolymer emulsion manufactured by Celanese Ltd. (Dallas, Tex.).

Buckeye Red dye 1 is a direct red dye. Buckeye Red dye 2 is a direct red dye. Buckeye Red dye 3 is a direct red dye. Buckeye Red dye 4 is a direct red dye. Buckeye Blue dye 1 is a direct blue dye. Buckeye Green dye 1 is a direct green dye. Buckeye Black dye 1 is a direct black dye.

Apple Red Beverage Napkin is a sample of a wetlaid colored structure by AMSCAN Inc. (Elmsford, N.Y.). Bright Royal Blue Beverage Napkin is a sample of a wetlaid colored structure by AMSCAN Inc. (Elmsford, N.Y.). Festive Green Beverage Napkin is a sample of a wetlaid colored structure by AMSCAN Inc. (Elmsford, N.Y.). Jet Black Beverage Napkin is a sample of a wetlaid colored structure by AMSCAN Inc. (Elmsford, N.Y.).

WALKISOFT® Red 117 is a sample of an airlaid colored structure in which the colored fibers are produced by comminuting a dyed cellulose comminution sheet, which has been produced in a wetlaid process by introducing dye to a slurry of individualized cellulose fibers.

WALKISOFT® Red 120 is a sample of an airlaid colored structure in which the colored fibers are produced by comminuting a dyed cellulose comminution sheet, which has been produced in a wetlaid process by introducing dye to a slurry of individualized cellulose fibers.

WALKISOFT® Printed Red 117 is a sample of an airlaid colored structure in which the colored fibers are produced by comminuting a dyed cellulose comminution sheet, which has been produced in a wetlaid process by introducing dye to a slurry of individualized cellulose fibers. A printed design has been added to airlaid material.

WALKISOFT® Blue 152 is a sample of an airlaid colored structure in which the colored fibers are produced by comminuting a dyed cellulose comminution sheet, which has been produced in a wetlaid process by introducing dye to a slurry of individualized cellulose fibers. A printed design has been added to airlaid material.

WALKISOFT® Green 142, a sample of an airlaid colored structure in which the colored fibers are produced by comminuting a dyed cellulose comminution sheet, which has been produced in a wetlaid process by introducing dye to a slurry of individualized cellulose fibers.

Red Flexographic Printed Napkin was generated when a sample of WALKISOFT® white produced by Buckeye Technologies Inc. (Memphis, Tenn.), was flexographically printed by Waldan Paper Services, Inc. (Oshkosh, Wis.). Flexographic printing entails the use of a flexible printing plate to print on a variety of substrates. Flexographic printing is also known as aniline printing.

The WALKISOFT® airlaid structures have been manufactured by an affiliate of Buckeye Technologies Inc. (Memphis, Tenn.).

HPF is a high purity mercerized bleached Southern softwood Kraft in the form of a cellulose comminution sheet manufactured by an affiliate of Buckeye Technologies Inc. (Memphis, Tenn.). HPF fibers are fabricated from cellulosic materials, primarily wood pulp from slash pine.

### Procedure 1: Tabletop Photometric Transmission Opacity Colorfastness Test for Dye or Pigment Bleed

### Experimental Sample Preparation Method

A 3.6513 cm (1.4375 in) punch is used to remove a circle from the material to be tested. The sample is placed in the bottom of a 100 mL beaker. 80 mL of water is added to the beaker. The sample is allowed to sit undisturbed overnight. The next day, the sample is agitated mildly with a stir rod, making sure not to contact the sample. 25 mL of the solution is transferred into a 30 mL beaker. It is important to make sure the solution does not have any air bubbles that may impede the measurement.

### Water Standard Preparation Method

Twenty-five milliliters of water is transferred into a 30 mL beaker. The water should be obtained at the same time from the same source used for the experimental sample. It is important to make sure the solution does not have any air bubbles that may impede the measurement.

### Experimental Procedure

The testing unit is composed of a 6-sided box of 0.64 cm (0.25 in) PLEXIGLAS®, of which one side has been lightly sandblasted or abraded and then painted a solid, flat black. The interior of the box was also painted black. PLEXIGLAS® is manufactured by Arkema, Inc., of Philadelphia, Pa. The overall exterior dimensions of the box shall be 20.32 cm×20.32 cm×16.51 cm (8 in×8 in×6.5 in). In the center of the top of the box, a hole has been drilled, sufficient to allow the probe of a SEKONIC® Digilite Model L-318 photography light meter to fit snugly, permitting minimal light leakage, allowing the body of the meter to be supported by the remaining surface of the box top. SEKONIC® Digilite Model L-318 photography light meters are manufactured by Sekonic USA of Elmsford, N.Y. A centered 10.16 cm×10.16 cm (4 in×4 in) square hole was cut in the bottom of the box. Small tabs or painted strips were placed on the vertical walls of the box at its base to indicate the outer dimensions of the 10.16 cm×10.16 cm (4 in×4 in) hole. This facilitates the placement of the test unit, ensuring that the opening is fully occluded by the sample.

A light box manufactured by Halsey X-Ray Products, Inc., of Brooklyn, N.Y., is turned on and allowed to operate for 900 s (15 min) prior to testing. A 15.24 cm×15.24 cm (6 in×6 in) sheet of opaque material with a central 3.8 cm (1.5 in) diameter circular opening is then centered on the light box. This light blocking template prevents light other than that passing through the test beaker to be evaluated. The beaker containing the water standard is placed in the circular opening in the light blocking template. The testing unit is then placed over the template ensuring the central opening is completely blocked out by the template. The placement guides may be used to assist in this effort. An exposure value (EV) is then determined for the water standard. To take experimental sample readings, the testing unit is removed so that the beaker containing the water standard can be replaced with a beaker containing an experimental sample. After the testing unit is replaced, an exposure value for the experimental sample may be determined. Values for the water standard may change over time. Experimental sample results are only relative to a water standard tested the same day. Percent opacity of the sample is determined by substitution into the following equation:

Opacity(percent)=100−((Exposure Value Experimental Sample(EV)/Exposure Value Water Standard(EV))×100)

The lower the percent opacity obtained for a given sample, the less the dye in the sample bled. Less dye bleeding is predictive of good wet crocking results from the American Association of Textile Chemists and Colorists (AATCC) test method 8. For example, a sample with 2 percent opacity might have good colorfastness to crocking results while a sample with 20 percent or 40 percent opacity might have poor colorfastness to crocking results. Negative percent opacity values might be observed due to several factors, such as fibers in the solution, differences in the sample beakers, or bubbles in the solution.

### Procedure 2: Basic Airlaid Handsheet Formation

Some working examples described herein employed a laboratory airlaid handsheet apparatus which lays down a 35.56 cm×35.56 cm (14 in×14 in) pad. This size pad is termed an airlaid handsheet and is suitable for laboratory scale experiments before going to an actual airlaid machine to produce a continuous web. The airlaid handsheet apparatus has a supported forming wire which can be removed and repositioned by rotating the forming wire 90 degrees. Vacuum is applied to bottom of the forming wire, while materials to be airlaid are air conveyed to the top of the forming wire. To make an airlaid handsheet on the airlaid handsheet former, a carrier tissue is placed on the forming wire to aid in the collection of material on the forming wire. One example of a tissue carrier often used is an 18 gsm, 1 ply, 1.6 cubic meters/min (55.3 cubic feet/minute) tissue manufactured by Cellu Tissue Holdings, Inc., of Alpharetta, Ga. Weighed amounts of various fibers are added to a mixing chamber where jets of air fluidize and mix the fibers. The fluidized cloud of fibers is pulled down onto the forming wire by the vacuum source.

Prior to feeding to the handsheet apparatus, chosen comminution sheet fibers are mechanically defibrated, or comminuted into a low density, individualized, fibrous form known as fluff. Mechanical defibration may be performed by a variety of methods which are known in the art. Typically a hammer mill is employed. One example of a hammer mill, a Type KVARN Kamas Mill from Kamas Industri AB, Sweden with a 51 mm (2 in) slot, is particularly useful for laboratory scale production of fluff. Additionally, a three stage fluffer is another example of a laboratory comminution device. For larger samples, a hammer mill such as a Type H-12-KD Kamas Mill from Kamas Industri AB, Sweden with a 101.6 mm (4 in) slot is employed.

The laboratory scale airlaid handsheet apparatus can be operated step-wise to simulate the commercial multiple-forming-head airlaid process to airlay the fiber mixtures into the 35.56 cm (14 in) square handsheets. The airlaid handsheet former is located in a temperature- and relative humidity-controlled room maintained at 23° C.+1.5° C. (73.4° F.+2.7° F.) and 50+5 percent relative humidity. The fibrous raw materials are equilibrated in the controlled humidity room for at least 30 minutes prior to forming the handsheet. Controlling the humidity and temperature are necessary to avoid static electricity problems that can be generated in connection with the air-handling of finely divided materials.

For low basis weight materials, the airlaid handsheet apparatus is used to build an airlaid handsheet in up to twelve (12) steps to produce as many layers. Forming the airlaid handsheet in this many steps helps to ensure that the batch-type forming head of the laboratory airlaid handsheet apparatus better simulates the degree of homogeneity which is obtained in a multiple forming head, continuous airlaid manufacturing machine. After each portion of the total weight of fibers is laid down, the forming wire is turned 90 degrees in the apparatus. This procedure helps to minimize air turbulence artifacts and delivers a more uniform handsheet. In this step-wise fashion the entire airlaid handsheet is formed. Finally, a second carrier tissue is placed on the top of the handsheet.

After the airlaying step, the airlaid handsheet is trimmed to 30.48 cm×30.48 cm (12 in×12 in) and pressed to a target thickness in a model 4533.4DI0A00 Carver hydraulic laboratory press manufactured by Carver, Inc. of Wabash, Ind. The airlaid handsheet is then held under dual platen heated compression for 60 seconds at 150° C. (302° F.).

After 60 seconds of compression, the airlaid handsheet is removed from the press. The handsheet is placed on a vacuum box, the top layer of tissue is removed, and a target amount of a latex binder is sprayed onto the airlaid handsheet under vacuum via a PREVAL® sprayer. A PREVAL® sprayer is a spray gun applicator which disperses fluids as a fine mist. The airlaid handsheet is cured in a 150° C. (302° F.) oven for 30 seconds. The airlaid handsheet is then placed back onto the vacuum box so that the bottom side of the sample is exposed, the bottom layer of tissue is removed, and a target amount of a latex binder is sprayed onto the airlaid handsheet under vacuum via a PREVAL® sprayer. The airlaid handsheet is cured in a 150° C. (302° F.) oven for 30 seconds. During the final step in sample preparation, the airlaid handsheet is pressed to a target thickness in a laboratory press heated to 150° C. (302° F.). The airlaid handsheet is then held under compression for 60 seconds.

### Procedure 3: Colorfastness to Crocking

Crocking can be defined as color transfer by rubbing, that is dye transfer by mechanical abrasion or contact with the dyed material. In American Association of Textile Chemists and Colorists (AATCC) test method 8, the method to measure the amount of color transfer is standardized. For AATCC test method 8, samples are preconditioned a minimum of (14400 s) 4 hr in a temperature [21° C. (69.8° F.)+/−1° C. (33.8° F.)] and relative humidity (65 percent +/−2 percent) controlled room prior to testing. After proper conditioning, the testing material is placed on a crock meter over an abrasive cloth. One example of a manual crock meter would be a Crockmaster Model 670 manufactured by James H. Heal & Co. Ltd. of Halifax, England. This type of crock meter uses 3M TRIZACT® anti-slip abrasive cloth manufactured by 3M of St. Paul, Minn., which is comparable in performance to 280 grit sandpaper. A standard preconditioned undyed test cloth square is placed on the crock finger located parallel with the specimen plate. One example of such test cloth would be a Heals Crocking Cloth or AATCC Style 3 Crocking Cloth both of which are manufactured by James H. Heal & Co. Ltd. of Halifax, England. This finger located on the weighted test arm is rubbed back and forth at a rate of 1 turns for 10 complete turns. The test cloth is then removed from the crock finger, lint or other fiber transfer are removed, air dried, and re-conditioned prior to comparison to a gray scale.

The test cloth is compared to gray scale or chromatic transference scale with 9 divisions (1, 1-2, 2, 2-3, 3, 3-4, 4, 4-5, 5) under a standard light source to determine the amount of staining Examples of an AATCC Gray Scale for Staining or an AATCC Chromatic Transference Scale are manufactured by James H. Heal & Co. Ltd. of Halifax, England. The standard light source is comprised of a daylight illuminant source such as a D₆₅ bulb incident upon the sample at an angle of 45 degrees. The angle of viewing should be 90 degrees relative to the sample. The viewing environment where the standard light source and sample are located should be a clean, empty, matte gray surface matching Munsell N6/to N8/that is shielded from extraneous light. Many examples of viewing cabinets which meet AATCC criteria exist including the GTI MINIMATCHER® MM2E manufactured by GTI Graphic Technology Inc. of Newburgh, N.Y.

After the test cloth is compared to the gray scale or chromatic transference scale the step change on the scale is then assigned a corresponding Grade. On each scale, Grade 5 corresponds to Step 5 and indicates little or no change of the color of the white test cloth. Grade 1 corresponds to Step 1 and indicates significant change in color of the white test cloth. The test is the same for wet crocking samples with the exception that the preconditioned undyed test cloth is adjusted to 65 percent+/−5 percent moisture content with distilled water prior to placing it on the crock finger.

### Example 1

### Manifold Application of Red Dye Utilizing a Hammer Mill in Attempt to Distribute Dye Evenly Through Defibrated Fluff Pulp

The raw materials consisted of FOLEY FLUFFS® and Buckeye Red dye 1. A manifold applicator was used to apply Buckeye Red dye 1 to both sides of the fluff pulp comminution sheet using a peristaltic pump. The fluff pulp comminution sheet then entered a hammer mill with a 101.6 mm (4 in) slot where it was mechanically defibrated. The comminuted fluff pulp was then collected in a bag on the discharge side of the transfer fan. Each defibrated sample was dried at 105° C. (221° F.).

TABLE 1
Manifold addition of Buckeye Red Dye 1 at hammer mill

| | | Basis | | |
|---|---|---|---|---|
| | Basis | Weight of | | |
| | Weight of | Buckeye Red | | |
| | Foley Fluffs ® | RSF-64 Liquid | Percent Sample | Resulting |
| Ex- | Prior to Dye | Dye version 1 | Moisture After | Defibrated |
| ample | Addition (gsm) | Addition (gsm) | Dye Addition | Fiber Color |
| 1a | 750 | 187.5 | 25 | pink |
| 1b | 750 | 225 | 30 | pink |
| 1c | 750 | 262.5 | 35 | dark pink |
| 1d | 750 | 300 | 40 | light red |

It was observed that it was difficult to get uniform dye coverage on fibers when relying on a hammer mill to redistribute the dye. Additions resulting in sufficient coverage to obtain a deep red would result in percent moisture contents too great for hammer mill processing. The maximum total percent sample moisture that results in good hammer mill processing is 20 percent.

### Example 2

### Spray Dying of Pulp Sheets to Target Moisture Contents and Pressing of Sheets to Target Applied Loads to Determine Minimum Red Dye Addition Necessary to Completely Coat the Fibers and Result in a Deep Red Color

The raw materials consisted of FOLEY FLUFFS® and Buckeye Red dye 1. A PREVAL® sprayer was used to apply one half of the target moisture add-on to each side of the fluff pulp comminution sheet. After application of Buckeye Red dye 1 to each side of the fluff pulp comminution sheet, the fluff pulp comminution sheet was pressed by running through mini press roll unit 2 at a speed of 2 m/min. This press is comprised of a Dayton Model 2Z846D motor turning a rubber/metal roll Metro Fluid Dynamics pneumatic press. The pressed fluff pulp comminution sheet was torn open at one end while wet so that the core of the fluff pulp comminution sheet could be evaluated for dye penetration. The fluff pulp comminution sheet was then dried at 105° C. (221° F.) for 1 hr. A 2.54 cm×2.54 cm (1 in×1 in) strip of the fluff pulp comminution sheet was placed in 25 mL of water and allowed to soak undisturbed for 24 hr. The supernatant liquid of the sample was examined visually for evidence of dye bleed. For a segment of the samples that demonstrated noticeably less dye bleed, the remainder of the dry fluff pulp comminution sheet was then cut into 2.54 cm×10.16 cm (1 in×4 in) strips and mechanically defibrated via a three-stage fluffer, which is a laboratory scale comminution device. The color of that defibrated material was then examined to ensure all fibers were consistently colored with dye. To be considered red, all of the fibers had to be dyed. Any white fibers that were not fully dyed red gave the sample a pink or light red appearance.

TABLE 2
Minimization of Excess Dye Necessary to Achieve Deep Red Color

| | Applied | Total Percent | | | | | |
|---|---|---|---|---|---|---|---|
| | Roll | Fluff Pulp | | Excess | | | |
| | Loading | Comminution | Did Dye | Dye | Fluff Pulp | Fiber Color | |
| | [kg/linear | Sheet | Penetrate | on | Comminution | After Three- | Degree |
| | meter | Moisture | Into Sheet | Press | Sheet | Stage | of Dye |
| Example | (PLI)] | (After Press) | Core? | Roll? | Color | Fluffer | Bleed |
| 2A | 1787 | 34.84 | No | No | dark pink | dark pink | Some |
| | (100) | | | | | | |
| 2B | 2234 | 34.87 | No | No | dark pink | light red | Some |
| | (125) | | | | | | |
| 2C | 2681 | 35.58 | No | No | dark pink | red | Some |
| | (150) | | | | | | |
| 2D | 3127 | 35.47 | Yes | No | dark pink | red | Some |
| | (175) | | | | | | |
| 2E | 1340 | unknown | No | No | dark pink | unknown | Some |
| | (75) | | | | | | |
| 2F | 1787 | unknown | No | No | dark pink | unknown | Some |
| | (100) | | | | | | |
| 2G | 1787 | 37.47 | No | No | dark pink | dark pink | Some |
| | (100) | | | | | | |
| 2H | 2234 | 35.48 | Some | No | dark pink | unknown | Some |
| | (125) | | | | | | |
| 2I | 2234 | 37.81 | Yes | No | dark pink | light red | Some |
| | (125) | | | | | | |
| 2J | 2681 | 36.03 | Yes | No | dark pink | unknown | Some |
| | (150) | | | | | | |
| 2K | 2681 | 37.32 | Yes | No | dark pink | red | Some |
| | (150) | | | | | | |
| 2L | 3127 | 37.54 | Yes | No | dark pink | red | Some |
| | (175) | | | | | | |
| 2M | 447 | 40.65 | No | No | red | unknown | Major |
| | (25) | | | | | | |
| 2N | 894 | 40.96 | Yes | No | red | unknown | Major |
| | (50) | | | | | | |
| 2O | 1340 | unknown | Yes | No | red | unknown | Major |
| | (75) | | | | | | |
| 2P | 1787 | unknown | Yes | No | red | unknown | Major |
| | (100) | | | | | | |
| 2Q | 447 | 42.62 | No | No | red | unknown | Major |
| | (25) | | | | | | |
| 2R | 894 | 42.19 | Yes | No | red | unknown | Major |
| | (50) | | | | | | |
| 2S | 1340 | unknown | Yes | No | red | unknown | Major |
| | (75) | | | | | | |
| 2T | 1787 | unknown | Yes | No | red | unknown | Major |
| | (100) | | | | | | |
| 2U | 447 | 44.96 | No | No | red | unknown | Major |
| | (25) | | | | | | |
| 2V | 894 | 44.55 | Yes | Yes | red | unknown | Major |
| | (50) | | | | | | |
| 2W | 1340 | unknown | Yes | Yes | red | unknown | Major |
| | (75) | | | | | | |
| 2X | 1787 | unknown | Yes | Yes | red | unknown | Major |
| | (100) | | | | | | |

From this data it was observed that reducing addition of the dye solution to about 40 percent total moisture or less reduced dye bleed significantly. Merely reducing the dye addition did not prevent bleed completely, and did in some cases result in a pink or lighter red sample. Increasing loading by the press rolls did help in forcing dye throughout the sheet and demonstrated the minimum pressure required to fully disperse the dye throughout the fibers for any given moisture content. At levels as low as 35 percent total moisture, the defibrated fibers were observed to be red. Consistently deep reds were obtained with additions of about 40 percent or greater total moisture, but did result in greater dye bleed. At addition levels of about 45 percent total moisture, enough excess dye was present that it was forced out of the sheet on to the press rolls.

### Example 3

### Optimization of Latex Application to Prevent Dye Bleed

The raw materials consisted of defibrated material produced as described in Example 1D. Procedure 2 was followed to convert the fluff pulp comminution sheets into an airlaid handsheet form that simulated production airlaid material. Two 60 gsm airlaid handsheets were formed and pressed to a target thickness of 0.55 mm (0.022 in). After trimming to 30.48 cm×30.48 cm (12 in×12 in), each airlaid handsheet was cut into 4 equal quadrants prior to latex application. The tissue was removed from both sides each airlaid handsheet section prior to addition of between 6 to 12 percent solids by weight of latex binder to either side of the airlaid handsheet on the vacuum box. The latex binder emulsion used in this example varied between 3 to 12 percent solids of DUR-O-SET® Elite 22. A 3.6513 cm (1.4375 in) punch was used to remove a circle from the airlaid handsheet. This punched circle was placed in water and allowed to soak undisturbed overnight. The supernatant liquid of the sample was examined visually for evidence of dye bleed.

TABLE 3
Optimization of Latex Addition to Prevent Dye Bleed

| | | Total DUR-O-SET ® | |
|---|---|---|---|
| | | Elite 22 Solids | Did the |
| | DUR-O-SET ® Elite 22 | Application by Weight, | Sample |
| Example | Emulsion Solids, Percent | Percent | Bleed? |
| 3a | 12 | 12 | No |
| 3b | 9 | 12 | No |
| 3c | 6 | 12 | No |
| 3d | 3 | 12 | No |
| 3e | 3 | 15 | No |
| 3f | 3 | 18 | No |
| 3g | 3 | 21 | No |
| 3h | 3 | 24 | No |

It was observed that total latex additions of 12 to 24 percent solids by weight successfully prevented dye bleed. Variation of latex emulsion solids between 3 to 12 percent had no impact on dye bleed. It was noted qualitatively that lower percent emulsion solids contributed to deeper latex penetration into the web, ensuring more consistent coating of dyed fibers.

### Example 4

### Scaled Up Spray Dying of Fluff Pulp Comminution Sheets to Optimized Target Moisture Additions of Buckeye Red Dye 1 at Optimized Target Applied Loads

The raw materials consisted of FOLEY FLUFFS® and Buckeye Red dye 1. A PREVAL® sprayer was used to apply one half of the target moisture add-on to each side of the fluff pulp comminution sheet. After application of Buckeye Red dye 1 to each side of the fluff pulp comminution sheet, the fluff pulp comminution sheet was pressed by running through mini press roll unit 2 at a speed of 2 m/min. This press is comprised of a Dayton Model 2Z846D motor turning a rubber/metal roll Metro Fluid Dynamics pneumatic press. The pressed fluff pulp comminution sheet was torn open at one end while wet so that the core of the sheet could be evaluated for dye penetration. The fluff pulp comminution sheet was then dried at 105° C. (221° F.) for a minimum one hour until the sample was bone dry. Procedure 2 was followed to convert the fluff pulp comminution sheets into an airlaid handsheet form that simulated production material.

For this example, each fluff pulp comminution sheet was fed into a hammer mill with a 10.16 cm (4 in) slot to mechanically defibrate the sample prior to handsheet formation. A portion of the fluff pulp comminution sheet was reserved for additional testing. 51 gsm airlaid handsheets were formed and pressed to a target thickness of 0.55 mm (0.022 in). The tissue was removed from both sides of the airlaid handsheet prior to addition of 6 percent of latex binder to each side of the airlaid handsheet on the vacuum box. The latex binder used in this example was a 12 percent solids emulsion of DUR-O-SET® Elite 22. Procedure 1 was followed to test each fluff pulp comminution sheet and airlaid handsheet.

TABLE 4
Scaled Up of Optimized Dying Procedure Buckeye Red dye 1

| | | | Percent | |
|---|---|---|---|---|
| | Applied Roll | Total Percent Fluff | Opacity | Percent |
| | Loading | Pulp Comminution | Fluff Pulp | Opacity |
| Ex- | [kg/linear | Sheet Moisture | Comminution | Airlaid |
| ample | meter (PLI)] | (After Press) | Sheet | Handsheet |
| 4a | 3127 (175) | 35.16 | 8.9 | 2.1 |
| 4b | 2681 (150) | 37.71 | 6.7 | 4.2 |
| 4c | 670 (37.5) | 40.28 | 6.7 | 4.2 |

It was observed that the 12 percent solids by weight DUR-O-SET® Elite 22 addition successfully reduced the dye bleed from the handsheets. It was also observed that the percent opacity of the bleed water from the fluff pulp comminution sheets was decreased by limiting the amount of excess dye present in the fluff pulp comminution sheet.

### Example 5

### Attempt to Optimized the Addition of Buckeye Red Dye 2 to Prevent Dye Bleed

The raw materials consisted of FOLEY FLUFFS® and Buckeye Red dye 2. A strip of FOLEY FLUFFS® was dipped twice in a beaker containing Buckeye Red dye 2 and allowed to become fully saturated with the dye. The moisture contents of some of the FOLEY FLUFFS® sheets were adjusted with water to target moisture contents prior to dye addition. After application of Buckeye Red dye 2 to the fluff pulp comminution sheet, the fluff pulp comminution sheet was placed between two blotters and pressed in a laboratory bench top Carver Model C press. The fluff pulp comminution sheets were then dried at 105° C. (221° F.) for two hours. A strip from each fluff pulp comminution sheet was placed in water and allowed to soak undisturbed overnight. The supernatant liquid of the sample was examined visually for evidence of dye bleed. None of the samples showed any evidence of dye bleed.

TABLE 5
Methods Used to Eliminate Excess Buckeye Red dye 2 Addition

| | | Total Percent | Total Percent |
|---|---|---|---|
| | | Fluff Pulp | Fluff Pulp |
| | Total Percent Fluff | Comminution | Comminution |
| | Pulp Comminution | Sheet Moisture | Sheet |
| | Sheet Moisture | (After | Moisture |
| Example | (Before Dye Addition) | Dye Addition) | (After Press) |
| 5a | 6 to 7 | 47 | 47 |
| 5b | 6 to 7 | 47 | 35 |
| 5c | 20 | 47 | 47 |
| 5d | 30 | 47 | 47 |
| 5e | 40 | 47 | 47 |

It was observed that adjusting the moisture content of the fluff pulp comminution sheet prior to dye addition successfully limits the amount of excess dye able to soak into the sheet resulting in minimized dye bleed. It was also observed that pressing excess moisture out of the sheet successfully minimized dye bleed.

### Example 6

### Scaled-Up Addition of Buckeye Red Dye 2 to Prevent Dye Bleed

The raw materials consisted of FOLEY FLUFFS® and Buckeye Red dye 2. A rolled up strip of FOLEY FLUFFS® was placed in a beaker containing Buckeye Red dye 2 and allowed to become fully saturated with the dye. After application of Buckeye Red dye 2 to the fluff pulp comminution sheet, the fluff pulp comminution sheet was unrolled and pressed by running through the mini press roll unit 1 at approximately 3 m/min. Roll pressure was set to 551.6 kPa (80 psi). This press is comprised of a Dayton model 4Z382b motor turning a rubber/metal roll pneumatic press. The fluff pulp comminution sheet was then dried at 105° C. (221° F.) for two hours. A piece of the fluff pulp comminution sheet was reserved for bleed testing. Procedure 2 was followed to convert the fluff pulp comminution sheets into an airlaid handsheet form that simulated production material.

For this example, each fluff pulp comminution sheet was fed into a hammer mill with a 10.16 cm (4 in) slot to mechanically defibrate the sample prior to airlaid handsheet formation. A 60 gsm airlaid handsheet was formed for the experimental condition and pressed to a target thickness of 0.55 mm (0.022 in). The tissue was removed from both sides of the airlaid handsheet prior to the addition of 6 percent of latex binder to either side of the airlaid handsheet on the vacuum box. The latex binder emulsion used in this example was a 12 percent solids emulsion of DUR-O-SET® Elite 22. A 3.6513 cm (1.4375 in) punch was used to remove a circle from the airlaid handsheet and from the fluff pulp comminution sheet. These circles were placed in water and allowed to soak undisturbed overnight. The next day the supernatant liquid of each sample was examined visually for evidence of dye bleed.

Neither the fluff pulp comminution sheet nor the airlaid handsheet showed dye bleed. These samples were allowed to sit for some time after dye application before testing. It has been observed that these dyes often continue to fix on their own if there is a gap in time between the preparation of the sample and its testing.

### Example 7

### Preparation of Raw Materials for Pilot Plant Trial 1

The raw materials consisted of FOLEY FLUFFS®, Buckeye Red dye 3, and Buckeye Red dye 4. The dye solutions were mixed in a 5-gallon bucket with an electric mixer. The dyes were then used to treat a 10.16 cm (4 in) wide roll of FOLEY FLUFFS®. After application of dye to the fluff pulp comminution sheet via dipping in a puddle press, the fluff pulp comminution sheet was unrolled and pressed by running through the mini press roll unit 1 at approximately 7.5 m/min and a pressure of 689.5 kPa (100 psi). This press is comprised of a Dayton model 4Z382b motor turning a rubber/metal roll pneumatic press. Moisture contents were controlled by setting the speed fast enough to control the amount of dye metered on to the sample. The press then functioned to spread the dye more evenly through the colored cellulose comminution sheet. Moisture content was determined for each dyed fluffs comminution sheet after dye addition and sample pressing. The dyed cellulose comminution sheets were then rolled, and the rolls were then dried in a 50° C. (122° F.) oven for 5 days. The large rolls were saved for pilot plant use. A small piece of each roll was also collected and dried in a 105° C. (221° F.) oven until no additional moisture was lost. This material was used to make airlaid handsheets. These airlaid handsheets simulated the conditions planned for the pilot plant run.

TABLE 6
Composition and Description of Dyed FOLEY FLUFFS ®
Material for Handsheets and Pilot Plant Work

| | | | Total Percent |
|---|---|---|---|
| Example | Fluff Pulp | Dye Solution | Moisture |
| 7a | FOLEY | Buckeye Red | 44.81 |
| | FLUFFS ® | Dye 1 | |
| 7b | FOLEY | Buckeye Red | 47.91 |
| | FLUFFS ® | Dye 2 | |

### Example 8

### Handsheets Formed to Simulate Conditions of Pilot Plant Work

Raw materials for the airlaid handsheets consisted of dyed fluff pulp comminution sheet samples prepared according to the description in example 7. Procedure 2 was followed to convert the dyed fluff pulp comminution sheets into an airlaid handsheet form that simulated production material. For this example, each fluff pulp comminution sheet was fed into a hammer mill with a 10.16 cm (4 in) slot to mechanically defibrate the sample prior to handsheet formation. A piece of the fluff pulp comminution sheet was reserved for bleed testing. Airlaid handsheets were formed for each experimental condition and pressed to a target thickness of 0.55 mm (0.022 in). The latex binder emulsion used in this example was a 9 percent solids emulsion of DUR-O-SET® Elite 22. Procedure 1 was followed to test each fluff pulp comminution sheet and airlaid handsheet. The composition of the airlaid handsheets is described in Table 7. The opacity results are detailed in Table 8.

TABLE 7
Composition of Handsheets Blown To Simulate Pilot Plant Conditions

| | | | | Total Percent | |
|---|---|---|---|---|---|
| | Dyed Fluff | Basis Weight | Total Basis | Solids by Dry | |
| | Pulp | Defibrated Dyed | Weight | Weight | Total |
| | Comminution | Fluff Pulp | DUR-O-SET ® | DUR-O-SET ® | Basis Weight |
| | Sheet Roll | Comminution | Elite 22 | Elite 22 | Airlaid Handsheet |
| Example | Used | Sheet (gsm) | Applied (gsm) | Applied | (gsm) |
| 8a | 7a | 54.6 | 5.4 | 9 | 60 |
| 8b | 7b | 54.6 | 5.4 | 9 | 60 |
| 8c | 7a | 52.8 | 7.2 | 12 | 60 |
| 8d | 7b | 52.8 | 7.2 | 12 | 60 |

TABLE 8
Opacity Results for Dyed Fluff Pulp Comminution Sheet Rolls
and Airlaid Handsheets

| | Percent Opacity | Percent Opacity |
|---|---|---|
| Example | Fluff Pulp Comminution Sheet Roll | Airlaid Handsheet |
| 8a | 15.91 | 2.27 |
| 8b | 59.09 | 11.36 |
| 8c | 15.91 | 0.00 |
| 8d | 59.09 | 6.82 |

It was observed that 9 percent solids by dry weight DUR-O-SET® Elite 22 was not sufficient to fully prevent dye bleed. Consequently, the target latex application for pilot example 9 was increased.

### Example 9

### Pilot Example 1

In addition to the airlaid handsheet samples, an airlaid substrate was prepared on a DannWeb pilot scale airlaid manufacturing unit at Buckeye Technologies Inc. in Memphis, Tenn. The raw materials consisted of dyed fluff pulp comminution sheet rolls 8a and 8b prepared according to the description in example 8 as well as a 9 percent solids emulsion of DUR-O-SET® Elite 22. The first forming head added dyed FOLEY FLUFFS® fibers. Immediately after this, the web was compacted via the compaction roll set at 600 kPa (6 bar). Then, DUR-O-SET® Elite 22 was sprayed onto the top of the web. The web was cured in a Moldow Through Air Tunnel Dryer at a temperature of 150° C. (302° F.). After this, the web was wound and collected. The web was re-oriented at the front of the line so that additional DUR-O-SET® Elite 22 could be applied to the opposite side of the web. Then the web was cured in a Moldow Through Air Tunnel Dryer at a temperature of 150° C. (302° F.). After this, the web was wound and collected. The machine speed was approximately 20 m/min. Procedure 1 was followed to test each fluff pulp comminution sheet and airlaid pilot plant material produced. The pilot substrates were prepared according to the compositions given in Table 9. The opacity data is listed in Table 10.

TABLE 9
Composition of Pilot Plant Conditions at Buckeye Technologies Inc.
in Memphis, Tennessee

| | Dyed | Basis Weight | Total Basis | Total Percent | |
|---|---|---|---|---|---|
| | Fluff Pulp | Defibrated Dyed | Weight | Solids by Dry | Basis Weight |
| | Comminution | Fluff Pulp | DUR-O-SET ® | Weight DUR- | Total Airlaid |
| | Sheet | Comminution | Elite 22 | O-SET ® Elite | Pilot Substrate |
| Example | Roll Used | Sheet (gsm) | Applied (gsm) | 22 Applied | (gsm) |
| 9a | 7a | 52.8 | 7.2 | 12 | 60 |
| 9b | 7b | 52.8 | 7.2 | 12 | 60 |
| 9c | 7a | 51.0 | 9.0 | 15 | 60 |
| 9d | 7b | 51.0 | 9.0 | 15 | 60 |

TABLE 10
Opacity Results for Dyed Fluff Pulp Comminution Sheet Rolls
and Airlaid Pilot Substrate Material Produced at Buckeye
Technologies Inc. in Memphis, Tennessee

| | Percent Opacity Fluff | Average Percent Opacity |
|---|---|---|
| Example | Pulp Comminution Sheet | Airlaid Pilot Substrate Material |
| 9a | 15.91 | 2.83 |
| 9b | 50.00 | 4.50 |
| 9c | 15.91 | −2.91 |
| 9d | 50.00 | −0.29 |

Through this pilot work it was verified that latex application could control dye bleed.

### Example 10

### Preparation of Raw Materials for Pilot Plant Trial 2

The raw materials consisted of FOLEY FLUFFS® and Buckeye Red dye 3. The dye solution was mixed in a 5-gallon bucket with an electric mixer. The dye was then used to treat a 10.16 cm (4 in) wide roll of FOLEY FLUFFS® fluff pulp comminution sheet via dipping in a puddle press, and then the fluff pulp comminution sheet was pressed by running it through the mini press roll unit 1 at a pressure of 689.5 kPa (100 psi) and a speed of approximately 7.5 m/min. This press is comprised of a Dayton model 4Z382b motor turning a rubber/metal roll pneumatic press. Sample moisture contents were controlled by setting the speed fast enough to control the amount of moisture metered on. The press then functioned to spread the dye evenly through the fluff pulp comminution sheet roll.

A moisture content was determined for each dyed fluff pulp comminution sheet roll after dye addition and sample pressing. Three rolls were produced. The average total percent moisture of the dyed fluff pulp comminution sheet roll was 47.15 percent. The rolls were then dried in a 50° C. (122° F.) oven for 7 days.

### Example 11

### Pilot Example 2

An airlaid substrate was prepared on a DannWeb pilot scale airlaid manufacturing unit at Buckeye Technologies Inc. in Memphis, Tenn. The raw materials consisted of dyed fluff pulp comminution sheet roll prepared according to the description in example 10 as well as a 9 percent solids emulsion of DUR-O-SET® Elite 22. The first forming head added dyed FOLEY FLUFFS® fibers. Immediately after this, the web was compacted via the compaction roll set at 600 kPa (6 bar). Then, DUR-O-SET® Elite 22 was sprayed onto the top of the web. The web was cured in a Moldow Through Air Tunnel Dryer at a temperature of 150° C. (302° F.). After this, the web was wound and collected. The web was re-oriented at the front of the line so that additional DUR-O-SET® Elite 22 could be applied to the opposite side of the web. Then the web was cured in a Moldow Through Air Tunnel Dryer at a temperature of 150° C. (302° F.). After this, the web was wound and collected. The machine speed was approximately 20 m/min. Procedure 1 was followed to test the fluff pulp comminution sheet and airlaid pilot plant material produced. The pilot substrate was prepared according to the compositions given in Table 11.

The opacity data is listed in Table 12.

TABLE 11
Composition of Pilot Plant Conditions at Buckeye Technologies Inc.
in Memphis, Tennessee

| | | Basis Weight | | | |
|---|---|---|---|---|---|
| | | Defibrated | Total Basis | Total Percent | Basis Weight |
| | | Dyed Fluff | Weight | Solids by Dry | Total Airlaid |
| | Dyed Fluff Pulp | Pulp | DUR-O-SET ® | Weight DUR- | Pilot |
| | Comminution | Comminution | Elite 22 | O-SET ® Elite | Substrate |
| Example | Sheet Roll Used | Sheet (gsm) | Applied (gsm) | 22 Applied | (gsm) |
| 11 | 10 | 52.8 | 7.2 | 12 | 60 |

TABLE 12
Opacity Results for Dyed Fluff Pulp Comminution Sheet Rolls
and Airlaid Pilot Substrate Material Produced at Buckeye
Technologies Inc. in Memphis, Tennessee

| | Percent Opacity Fluff | Average Percent Opacity |
|---|---|---|
| Example | Pulp Comminution Sheet | Airlaid Pilot Substrate Material |
| 11 | 54.81 | 1.75 |

Through this pilot work it was verified that latex application could control dye bleed.

### Example 12

### Evaluation of Latex Binding Technology on Blue, Green, and Black Dyes

The raw materials consisted of FOLEY FLUFFS®, Buckeye Blue dye 1, Buckeye Green dye 1, and Buckeye Black dye 1. Two thousand milliliters of each dye formulation were mixed. A 10.16 cm (4 in) wide roll of FOLEY FLUFFS® was curled up and placed in a beaker of dye solution. It was then removed from the beaker and turned over so the opposite edge of the roll was placed in the solution. This ensured that the blue, black, and green dyed samples were allowed to become completely saturated. Each fluff pulp comminution sheet roll was then pressed by running it through mini press roll unit 1 at approximately 7.5 m/min and a pressure of 689.5 kPa (100 psi). This press is comprised of a Dayton model 4Z382b motor turning a rubber/metal roll pneumatic press. Percent moisture was determined on each fluff pulp comminution sheet to evaluate dye uptake after pressing. Each sample was then dried at 50° C. (122° F.) overnight. Procedure 2 was followed to convert the fluff pulp comminution sheets into an airlaid handsheet form that simulated airlaid production material.

For this example, each fluff pulp comminution sheet was fed into a hammer mill with a 10.16 cm (4 in) slot to mechanically defibrate the sample prior to airlaid handsheet formation. The moisture contents of the dyed fluff pulp comminution sheet rolls and compositions of the airlaid handsheets are described in Tables 13 and 14. A piece of each fluff pulp comminution sheet was reserved for bleed testing. Airlaid handsheets were formed for each experimental condition and pressed to a target thickness of 0.55 mm (0.022 in). The latex binder emulsion used in this example was a 9 percent solids emulsion of DUR-O-SET® Elite 22. After airlaid handsheet formation, Procedure 1 was followed to test each fluff pulp comminution sheet and corresponding airlaid handsheet. Those percent opacity results are included in Table 15.

TABLE 13
Moisture Contents for Blue, Green, and Black Dyed
Fluff Pulp Comminution Sheets

| | | Total Percent |
|---|---|---|
| | | Moisture of Dyed Fluff Pulp |
| Example | Experimental Dye Solution | Comminution Sheet |
| 12a | Buckeye Blue dye 1 | 55.69 |
| 12b | Buckeye Green dye 1 | 55.40 |
| 12c | Buckeye Black dye 1 | 55.90 |

TABLE 14
Composition of Blue, Green, and Black Airlaid Handsheet Examples

| | | Basis Weight of | | |
|---|---|---|---|---|
| | Example Source of | Defibrated Dyed | Basis Weight of | |
| | Dyed Fluff Pulp | Fluff Pulp | DUR-O-SET ® Elite | Weight Percent |
| | Comminution | Comminution Sheet | 22 Sprayed Per Side | DUR-O-SET ® E- |
| Example | Sheet | (gsm) | of Handsheet (gsm) | 22 Solids |
| 11d | 12a | 52.8 | 3.6 | 12 |
| 11e | 12b | 52.8 | 3.6 | 12 |
| 11f | 12c | 52.8 | 3.6 | 12 |
| 11g | 12c | 51.0 | 4.5 | 15 |
| 11h | 12c | 49.2 | 5.4 | 18 |

TABLE 15
Opacity Results for Blue, Green, and Black Dyed Fluff Pulp
Comminution Sheet Rolls and Airlaid Handsheets

| | Percent Opacity | Average Percent Opacity |
|---|---|---|
| Example | Fluff Pulp Comminution Sheet | Airlaid Handsheet Material |
| 12d | 77.78 | 4.65 |
| 12e | 46.67 | 2.33 |
| 12f | 88.89 | 23.26 |
| 12g | 88.89 | 16.67 |
| 12h | 88.89 | 19.05 |

It was observed that the type of pressing utilized in combination with the soaking method used to treat the samples resulted in larger total percent moisture content for these dyed fluff pulp comminution sheet than for those evaluated in examples where red dye was used. It was also observed that the blue dye and green dye handsheet results were promising enough at this point to evaluate crocking via AATCC 8 as described in Procedure 3 at an independent laboratory. Those crocking results are included in Table 17. The black dyed sample contained too much excess dye to lock it down by this method. Even though the black dye in the handsheet was not completely bound by the latex, a significant amount was prevented from bleeding as compared to the dyed fluff pulp comminution sheet.

### Example 13

### Evaluation of Commercial Media by Procedure 1

This is not an example of the present invention. Procedure 1 was followed to test each material. These materials are various types and colors of competitive samples from media made by a process different than those described in this document.

TABLE 16
Opacity Results for Commercial Media

| Example | Sample Description | Percent Opacity |
|---|---|---|
| 13a | Apple Red Beverage Napkin | −4.67 |
| 13b | WALKISOFT ® Red 117 | 2.27 |
| 13c | WALKISOFT ® Red 120 | not applicable |
| 13d | WALKISOFT ® Printed Red 117, | not applicable |
| | tested on side opposite printing | |
| 13e | Red Flexographic Printed Napkin | 0.00 |
| 13f | Bright Royal Blue Beverage Napkin | −4.76 |
| 13g | Festive Green Beverage Napkin | −2.38 |
| 13h | Jet Black Beverage Napkin | −2.38 |
| 13i | WALKISOFT ® Blue 152 | −2.38 |
| 13j | WALKISOFT ® Green 142 | −7.14 |
| 13k | WALKISOFT ® Black 181 | −4.76 |

### Example 14

### Independent Colorfastness to Crocking Test Results

Various examples were submitted to Precision Testing Laboratories, which is located in Nashville, Tenn., for AATCC 8 Colorfastness to Crocking summarized in Procedure 3. The standard test was modified for these examples by reducing the number of turns from 10 as noted in the table due to the tendency of some of the samples to tear during testing.

TABLE 17
Wet and Dry Colorfastness to Crocking Results

| | | | Dry Rub | Wet Rub |
|---|---|---|---|---|
| | | Number | Grade | Grade |
| Example | Example Description | of Turns | Classification | Classification |
| 9a | FOLEY FLUFFS ®, Buckeye Red | 8 dry, | 4.5 | 3.0 |
| | Dye 3, 12 percent solids by dry | 5 wet | | |
| | weight DUROSET ® Elite 22, airlaid | | | |
| | pilot substrate material | | | |
| 9b | FOLEY FLUFFS ®, Buckeye Red | 8 dry, | 4.5 | 1.5 |
| | Dye 4, 12 percent solids by dry | 5 wet | | |
| | weight DUROSET ® Elite 22, airlaid | | | |
| | pilot substrate material | | | |
| 9c | FOLEY FLUFFS ®, Buckeye Red | 8 dry, | 4.0 | 2.5 |
| | Dye 3, 15 percent solids by dry | 5 wet | | |
| | weight DUROSET ® Elite 22, airlaid | | | |
| | pilot substrate material | | | |
| 9d | FOLEY FLUFFS ®, Buckeye Red | 8 dry, | 4.5 | 1.5 |
| | Dye 4, 15 percent solids by dry | 5 wet | | |
| | weight DUROSET ® Elite 22, airlaid | | | |
| | pilot substrate material | | | |
| 13a | Apple Red Beverage Napkin | 8 dry, | 4.0 | 2.0 |
| | | 5 wet | | |
| 13b | WALKISOFT ® Red 117 | 8 dry, | 4.0 | 1.5 |
| | | 5 wet | | |
| 13d | WALKISOFT ® Printed Red 117, | 8 dry, | 4.5 | 2.5 |
| | tested on side opposite printing | 5 wet | | |
| 13e | Red Flexographic Printed Napkin | 8 dry, | 4.0 | 2.5 |
| | | 5 wet | | |
| 12d | FOLEY FLUFFS ®, Buckeye Blue | 7 dry, | 5.0 | 2.5 |
| | Dye 1, 12 percent solids by dry | 7 wet | | |
| | weight DUROSET ® Elite 22, airlaid | | | |
| | handsheet | | | |
| 12e | FOLEY FLUFFS ®, Buckeye Green | 7 dry, | 5.0 | 3.0 |
| | Dye 1, 12 percent solids by dry | 7 wet | | |
| | weight DUROSET ® Elite 22, airlaid | | | |
| | handsheet | | | |
| 13i | WALKISOFT ® Blue 152 | 7 dry, | 3.5 | 1.5 |
| | | 7 wet | | |
| 13j | WALKISOFT ® Green 142 | 7 dry, | 4.5 | 3.5 |
| | | 7 wet | | |
| 11 | FOLEY FLUFFS ®, Buckeye Red | 7 dry, | 4.5 | 1.5 |
| | Dye 3, 12 percent solids by dry | 7 wet | | |
| | weight DUROSET ® Elite 22, airlaid | | | |
| | pilot substrate material | | | |
| 13b | WALKISOFT ® Red 117 | 7 dry, | 4.0 | 2.0 |
| | | 7 wet | | |

### Example 15

### Attempt to Use DUR-O-SET® Elite Plus 25-299a to Prevent Dye Bleed

Raw materials consisted of a dyed fluff pulp comminution sheet sample prepared according to the description in example 7a for airlaid handsheets. Procedure 2 was followed to convert the fluff pulp comminution sheet into an airlaid handsheet form that simulated airlaid production material. For this example, the fluff pulp comminution sheet was fed into a hammer mill with a 10.16 cm (4 in) slot to mechanically defibrate the sample prior to airlaid handsheet formation. A piece of the fluff pulp comminution sheet was reserved for bleed testing. A handsheet was formed for each experimental condition and pressed to a target thickness of 0.55 mm (0.022 in). The latex binder emulsion used in this example was a 9 percent solids emulsion of DUR-O-SET® Elite Plus 25-299a. The composition of the airlaid handsheet is described in Table 18.

Procedure 1 was followed to test the fluff pulp comminution sheet and airlaid handsheet for dye bleed. The percent opacity results are included in Table 19.

TABLE 18
Composition of Handsheet Blown to test Celanese DUR-O-SET ®
Elite Plus 25-299a

| | | Basis Weight | | | |
|---|---|---|---|---|---|
| | | Defibrated | | | |
| | | Dyed Fluff | Total Basis | Total Percent | Total Basis |
| | Dyed Fluff | Pulp | Weight DUR-O- | by Dry Weight | Weight |
| | Pulp | Comminution | SET ® Elite Plus | DUR-O-SET ® | Airlaid |
| | Comminution | Sheet | 25-299a Applied | Elite Plus 25- | Handsheet |
| Example | Sheet Used | (gsm) | (gsm) | 299a Applied | (gsm) |
| 14 | 7a | 52.8 | 7.2 | 12 | 60 |

TABLE 19
Percent Opacity Results

| | Percent Opacity | Average Percent Opacity |
|---|---|---|
| Example | Fluff Pulp Comminution Sheet | Airlaid Handsheet |
| 14 | 21.43 | 2.38 |

### Example 16

### Comparison of Bleed Performance of Dyed FOLEY FLUFFS® Versus HPF

The raw materials consisted of FOLEY FLUFFS®, HPF, and Buckeye Red dye 1. A PREVAL® sprayer was used to apply one half of the target moisture addition to each side of the fluff pulp comminution sheet. The total target moisture application was 42 percent. After application of Buckeye Red dye 1 to each side of the fluff pulp comminution sheet, the fluff pulp comminution sheet was pressed by running through mini press roll unit 2 at a speed of 2 m/min. This press is comprised of a Dayton Model 2Z846D motor turning a rubber/metal roll Metro Fluid Dynamics pneumatic press. The fluff pulp comminution sheet was then dried at 105° C. (221° F.) for 1 hr. A piece of each fluff pulp comminution sheet was reserved for bleed testing.

The remainder of the dry fluff pulp comminution sheet was then cut into 2.54 cm×10.16 cm (1 in×4 in) strips and mechanically defibrated via a three-stage fluffer, which is a laboratory scale comminution device. Procedure 2 was followed to convert the fluff pulp comminution sheets into an airlaid handsheet form that simulated airlaid production material.

Airlaid handsheets with a total target basis weight of 60 gsm were formed for both experimental conditions and pressed to a target thickness of 0.55 mm (0.022 in). Of this 60 gsm total target basis weight, 15 percent by weight of the composition was a DUR-O-SET® Elite 22 latex emulsion. To obtain a 15 percent by weight application, 3.6 gsm on a dry solids basis of this 9 percent solution solids emulsion of DUR-O-SET® Elite 22 was applied to each side of the airlaid handsheet. After airlaid handsheet formation, Procedure 1 was followed to test each fluff pulp comminution sheet and corresponding airlaid handsheet. Those percent opacity results are included in Table 20.

TABLE 20
Opacity Results for Dyed Fluff Pulp Comminution
Sheet Rolls and Airlaid Handsheets

| | Type of Fluff | Percent Opacity | Average Percent |
|---|---|---|---|
| | Pulp | Fluff Pulp | Opacity Airlaid |
| Example | Comminution | Comminution Sheet | Handsheet Material |
| 16a | FF | 13.95 | 0.00 |
| 16b | HPF | 25.58 | 0.00 |

Additional materials used in the following experimental examples include the following:

DUR-O-SET® Elite PLUS is an ethylene vinyl acetate copolymer manufactured by Celanese Ltd. (Dallas, Tex.).

DUR-O-SET® Elite ULTRA is an ethylene vinyl acetate copolymer manufactured by Celanese Ltd. (Dallas, Tex.).

DUR-O-SET® 10A is an ethylene vinyl acetate copolymer manufactured by Celanese Ltd. (Dallas, Tex.).

OMNABOND™ 2463 is a self cross-linking styrene butadiene emulsion polymer manufactured by OMNOVA Solutions Inc. (Fairlawn, Ohio).

VINNAPAS® EN 1020 Dispersion is a self cross-linking vinyl acetate ethylene copolymer dispersion manufactured by Wacker Chemie AG (Köln, Germany).

Polycup™ 920A is a wet strength resin produced by Ashland Hercules Water Technologies, a commercial unit of Ashland Inc. (Wilmington, Del.) and is an aqueous solution of a cationic amine polymer-epichlorohydrin adduct.

WALKISOFT® Black 181 is a sample of an airlaid colored structure in which the colored fibers are produced by comminuting a dyed cellulose comminution sheet, which has been produced in a wetlaid process by introducing dye to a slurry of individualized cellulose fibers.

WALKISOFT® Burgundy 120 is a sample of an airlaid colored structure in which the colored fibers are produced by comminuting a dyed cellulose comminution sheet, which has been produced in a wetlaid process by introducing dye to a slurry of individualized cellulose fibers.

Buckeye Black dye 2, Buckeye Black dye 3, and Buckeye Burgundy dye 1 are mixtures of NOVOCRON® reactive dyes manufactured by the Textile Effects Division of Huntsman (High Point, N.C.). NOVACRON® reactive dyes are formulated for dyeing and printing cellulose fibers.

ALBAFIX® ECO, produced by the Textile Effects Division of Huntsman (High Point, N.C.), is a fastness improver, or dye fixative, for dyed cellulosic fibers.

Chemicals used as binder catalysts include citric acid of 99 percent purity produced by Aldrich Chemical Company, Inc. (Milwaukee, Wis.) and granular ammonium chloride produced by J. T. Baker Chemical Co. (Phillipsburg, N.J.).

For the following examples, airlaid handsheets formed from white, non-dyed FOLEY FLUFFS® were experimental controls for each example.

For examples 21, 22, and 23 the EDANA Method WSP 110.4 was modified by testing tensile on 2.54 cm (11n) strips with a clamp distance of 5.08 cm (2 in). A THWING-ALBERT EJA Vantage™ series tensile tester manufactured by the THWING-ALBERT Instrument Co. of Holly Springs, N.C., equipped with a 50 N load cell was utilized for testing.

### Example 17

### Pilot Scale Production of Rolls of Dyed Fluff Pulp Market Comminution Sheets

The raw materials used for this pilot scale work included FOLEY FLUFFS®, Buckeye Black dye 2, and Buckeye Burgundy dye 1. FOLEY FLUFFS® is a bleached Southern softwood Kraft in the form of a comminution sheet manufactured by an affiliate of Buckeye Technologies Inc., of Memphis, Tenn. FOLEY FLUFFS® brand fibers are fabricated from cellulosic materials, primarily wood pulp from slash pine. Buckeye Black dye 2 and Buckeye Burgundy dye 1 are reactive dyes.

Each dye solution was mixed in a 605.7 L (160 gallon) capacity mix tank and transferred via diaphragm pump to a 113.6 L (30 gallon) feed tank. A centrifugal pump was used to transfer the dye from the feed tank to the manifold applicators. Flow to the applicators was controlled by the use of needle valves and flow meters.

The 81.92 cm (32.25 in) fluff pulp comminution sheet was situated at the head of the line. The fluff pulp comminution sheet was unwound and fed past a sheet guide and into a drive roll to feed the fluff pulp comminution sheet into the section where moisture was applied along with dye as follows: after the drive roll, the sheet passed under a manifold applicator through which dye was first applied to the top surface of the sheet. The sheet then passed over a second manifold applicator through which dye was applied to the bottom of the sheet. An idler roll was used so that the dyed fluff pulp comminution sheet was held flush to the surface of the second manifold applicator. The first manifold was placed slightly lower than the second manifold so that the sheet maintained contact with the top applicator.

Each manifold applicator was made from about 1.27 cm (0.5 in) inner diameter stainless steel pipe drilled with about 170 to about 220 holes. Each hole ranged in size from about 0.0508 cm (0.020 in) to about 0.1524 cm (0.060 in). The holes were drilled in a single line to form a about 81.92 cm (32.25 in) hole pattern. For the line speed of about 9.14 meters/min (30 ft/min) used for this trial, the manifold applicators were set to feed a joint output of about 3.8 L/min (1 gallon/min) plus or minus about 15 percent. This amount of dye addition results in a total sheet moisture of about 44 to about 46 percent after the dyed fluff pulp comminution sheet is pressed. About 67 to about 75 percent of the total dye was applied through the first applicator. The remainder of the dye was applied through the second applicator. These applicators were equipped with recirculation capabilities so that pressure could be equalized within the system.

After manifold application of the dye to both sides of the fluff pulp comminution sheet, the dyed fluff pulp comminution sheet continued was allowed sufficient retention time for the dye to begin to distribute throughout the dyed fluff pulp comminution sheet. The dyed fluff pulp comminution sheet then passed through a wet press which served to further distribute the dye through the dyed fluff pulp comminution sheet. The pressures for the wet press were set to about 0 to 345 kPa (0 to 50 psi). The dyed fluff pulp comminution sheet then passed through twenty-one Black Clawson, Inc., steam dryer cans. Black Clawson, Inc is an Ohio corporation with its principal place of business in New York. The dryer cans were set up in three sections. In the first section, the temperature was set between 60 and 80 degrees Celsius. In the second section, the temperature was set between 100 and 135 degrees Celsius. In the final section, the temperature was set between 80 and 100 degrees Celsius. Upon exiting the drying section, the dyed fluff pulp market comminution sheet was threaded through a custom manufactured Wagner Industries, Inc (Stanhope, N.J.) accumulator prior to threading onto the winder manufactured by Maxcess International of Oklahoma City, Okla. The final total moisture in the sheet was about 4 to about 8 percent. This process was repeated to produce a total of four black dyed fluff pulp market comminution sheet rolls and a total of four burgundy dyed fluff pulp market comminution sheet rolls. The composition and description of these rolls is detailed in Table 21.

TABLE 21
Composition and Description of Dyed FOLEY
FLUFFS ® Rolls for Handsheets and
Commercial Scale Work

| | Fluff Pulp Market | | |
|---|---|---|---|
| | Comminution Sheet | | Total Percent |
| Example | Used | Dye Solution | Moisture |
| 17a | FOLEY FLUFFS ® | Buckeye Black dye 2 | 45.94 |
| 17b | FOLEY FLUFFS ® | Buckeye Black dye 2 | 43.88 |
| 17c | FOLEY FLUFFS ® | Buckeye Black dye 2 | 46.31 |
| 17d | FOLEY FLUFFS ® | Buckeye Black dye 2 | 44.81 |
| 17e | FOLEY FLUFFS ® | Buckeye Burgundy dye 1 | 42.56 |
| 17f | FOLEY FLUFFS ® | Buckeye Burgundy dye 1 | 43.98 |
| 17g | FOLEY FLUFFS ® | Buckeye Burgundy dye 1 | 45.33 |
| 17h | FOLEY FLUFFS ® | Buckeye Burgundy dye 1 | 44.31 |

### Example 18

### Handsheets Formed to Simulate Conditions of Experimental Commercial Production Scale Run

Raw materials for the airlaid handsheets consisted of dyed fluff pulp market comminution sheet samples prepared according to the description in example 17. A machine direction and cross direction sample was collected from the core and tail of each dyed roll resulting in four comparison dyed fluff pulp market comminution sheet samples per dyed roll. Procedure 2 was followed to convert the dyed fluff pulp market comminution sheets into an airlaid handsheet form simulating production material. For this example, each dyed fluff pulp market comminution sheet was fed into a hammer mill with a 10.16 cm (4 in) slot to mechanically defibrate the sample prior to handsheet formation. A piece of the dyed fluff pulp market comminution sheet was reserved for bleed testing. Airlaid handsheets were formed for each experimental condition and pressed to a target thickness of 0.55 mm (0.022 in). The latex binder emulsion used in this example was a 9 percent solids emulsion of DUR-O-SET® Elite 22.

Procedure 1 was followed to test each dyed fluff pulp market comminution sheet and dyed airlaid handsheet. Results for these samples were averaged for each roll. The composition of the airlaid handsheets is described in Table 22. The opacity results are detailed in Table 23. The colorfastness to crocking results are included in Example 24.

TABLE 22
Composition of Dyed Airlaid Handsheets Blown to Simulate Commercial
Production Conditions

| | | | | Total | |
|---|---|---|---|---|---|
| | | Basis Weight | Total Basis | Percent | Total Basis |
| | Dyed Fluff | Defibrated | Weight | Solids by | Weight |
| | Pulp Market | Dyed Fluff | DUR-O- | Dry Weight | Dyed |
| | Comminution | Pulp Market | SET ® Elite | DUR-O- | Airlaid |
| | Sheet Roll | Comminution | 22 Applied | SET Elite | Handsheet |
| Example | Used | Sheet (gsm) | (gsm) | 22 Applied | (gsm) |
| 18 a-h | 17 a-h | 51 | 9 | 15 | 60 |

TABLE 23
Opacity Results for Dyed Fluff Pulp Market Comminution
Sheet Rolls and Dyed Airlaid Handsheets

| | Percent Opacity Dyed Fluff | Percent |
|---|---|---|
| | Pulp Market Comminution | Opacity Dyed |
| Example | Sheet Roll | Airlaid Handsheet |
| 18a | 26.97 | 1.30 |
| 18b | 21.71 | 1.90 |
| 18c | 26.88 | 1.25 |
| 18d | 37.50 | 2.50 |
| 18e | 23.08 | 1.30 |
| 18f | 25.00 | 3.10 |
| 18g | 25.00 | 2.50 |
| 18h | 23.72 | 2.50 |

Taken in combination, the opacity and colorfastness to crocking results were considered to be favorable enough that a commercial scale experimental trial was executed.

### Example 19

### Commercial Scale Experimental Trial to Produced Dyed Nonwoven Material

An airlaid substrate was prepared on a M&J Airlaid Products A/S (Horsens, Denmark) commercial airlaid manufacturing unit located at Buckeye Canada Inc. located in Delta, British

Columbia. Raw materials for the commercial scale runs consisted of dyed fluff pulp market comminution sheet samples prepared according to the description in example 17, FOLEY FLUFFS®, and DUR-O-SET® Elite 22.

Two dyed fluff pulp market comminution sheet rolls used were defibrated by running the rolls through hammer mills. The first forming head added the dyed defibrated fluff pulp market comminution sheet material. Immediately after this, the web was compacted via the compaction roll. Then, a 7 percent solids emulsion of DUR-O-SET® Elite 22 was sprayed on the top of the web. The web was dried and partially cured in a through-air tunnel dryer. The web was flipped so that additional 7 percent solids emulsion of DUR-O-SET® Elite 22 could be sprayed on the opposite side of the web. Then, the web was dried and partially cured in a through-air tunnel dryer. The web was flipped again and allowed to proceed through a curing oven prior to winding the dyed nonwoven material. The machine speed was set at 53 meters per minute for the 60 gsm samples and at 62 meters per minute for the 52 gsm samples.

The control data for the FOLEY FLUFFS® nonwoven material is an average obtained over numerous commercial runs and represents typical commercial nonwoven material conditions.

The composition of the commercial scale airlaid nonwoven materials are described in Table 24. The opacity results are detailed in Table 25 as well as wet and dry tensile data. The colorfastness to crocking results are included in Example 33.

TABLE 24
Composition of Commercial Scale Dyed Nonwoven Material Conditions and
Comparative FOLEY FLUFFS ® Samples

| | | Basis Weight | Total Basis | | |
|---|---|---|---|---|---|
| | Fluff Pulp | Defibrated | Weight | Total Percent | |
| | Market | Fluff Pulp | DUR-O- | Solids by Dry | Total Basis |
| | Comminution | Market | SET ® Elite | Weight DUR- | Weight |
| | Sheet Rolls | Comminution | 22 Applied | O-SET Elite | Airlaid |
| Example | Used | Sheet (gsm) | (gsm) | 22 Applied | Sample (gsm) |
| 19a | Dyed Example | 51.6 | 8.4 | 14 | 60 |
| | 17a-d | | | | |
| 19b | Dyed Example | 44.7 | 7.3 | 14 | 52 |
| | 17a-d | | | | |
| 19c | Dyed Example | 51.6 | 8.4 | 14 | 60 |
| | 17e-h | | | | |
| 19d | Dyed Example | 44.7 | 7.3 | 14 | 52 |
| | 17e-h | | | | |
| 19e | FOLEY | 54.0 | 6.0 | 10 | 60 |
| | FLUFFS ® | | | | |
| 19f | FOLEY | 46.8 | 5.2 | 10 | 52 |
| | FLUFFS ® | | | | |

TABLE 25
Opacity and Tensile Results for Commercial Scale Dyed Nonwoven Material

| | | | Machine | | |
|---|---|---|---|---|---|
| | Percent | | Direction Dry | Cross Direction | |
| | Opacity | | Tensile | Dry Tensile | Cross Direction Dry |
| | Airlaid | Caliper | [grams/cm | [grams/cm | Tensile [grams/cm |
| Example | Sample | (mm) | (grams/in)] | (grams/in)] | (grams/in)] |
| 19a | 0.00 | 0.65 | 387 (984) | 325 (825) | 29 (74) |
| 19b | −0.60 | 0.62 | 360 (914) | 296 (753) | 24 (61) |
| 19c | −2.63 | 0.57 | 617 (1566) | 494 (1254) | 50 (128) |
| 19d | −1.97 | 0.54 | 443 (1124) | 394 (1002) | 28 (71) |
| 19e | not | 0.58 | 385 (977) | 318 (807) | 140 (356) |
| | applicable | | | | |
| 19f | not | 0.54 | 350 (890) | 285 (723) | 122 (311) |
| | applicable | | | | |

The opacity and colorfastness to crocking results were deemed to be acceptable; however, during wet tensile testing, the samples bled a small amount of excess dye. This was considered to be unacceptable and led to the development of a new, more sensitive dye bleed evaluation test method described in Procedure 4. Also, it was discovered that the samples had significantly lower cross directional wet tensile values than the corresponding white control samples.

Procedure 4: Tabletop Photometric Transmission Opacity Colorfastness High Pressure Test for Dye Bleed from Dyed Airlaid Sample Material

### Experimental Sample Preparation Method

A 15.2 cm×30.4 cm (6 in×12 in) piece of dyed airlaid sample is cut from the material to be tested. The cut sample is weighed, and the weight is recorded. The sample is folded in half across the short dimension. Folding is repeated twice more, yielding about a 5.1 cm×15.2 cm (2 in×6 in) sample. The two long dimension edges of the structure are hand-pressed to compact the edges to facilitate insertion of the sample into the sample holder. The sample holder is made from plastic sheeting of about 0.254 mm thickness, folded and heat sealed on both long dimensions and one short dimension to obtain a 5.1 cm×20.3 cm (2 in×8 in) bag, having one open end across one of the short dimensions. The narrow dimension of the folded dyed airlaid sample is inserted into the opening in the sample holder. The sample is inserted fully into the holder until the end of the sample contacts the end of the holder. Distilled water is added to the sample, equal to 8.5 times the sample weight. The sample is manually manipulated, sufficient to insure that water has contacted all fibers of the dyed airlaid sample material. The sample, in its holder, is laid flat in the horizontal position for a period of 5 minutes. The open end of the sample holder is then inserted into a container capable of holding 20 to 50 ml of expressed fluid.

Mini press roll unit 2 is used to expel the excess dye from the dyed airlaid sample. Mini press roll unit 2 has a Dayton Model 2Z846D motor turning a rubber/metal roll Metro Fluid Dynamics pneumatic press. This press unit is activated with the rollers closed and rotating away from the container and sample holder at a surface velocity of 2 m/min. The roll pressure is set at 206.8 kPa (30 psi). The rollers are pneumatically separated after the pressure is stabilized. The container holding the inverted sample holder is placed so the upper, sealed end of the holder is between the open rollers of mini press roll unit 2. The rollers are pneumatically closed and set so that they contact the end of the sample holder and pull the sample holder through the rollers. The expelled fluid is captured in the container used to support the sample holder prior to insertion between the press rolls. A 4 ml aliquot of the expelled fluid is placed in a clear glass vial and sealed.

### Water Standard Preparation Method

Four milliliters of water is transferred into a clear glass vial. The water is obtained at the same time from the same source used for the experimental sample. It is important to make sure the water does not have any air bubbles that may have a negative influence on the measurement. The vial is then sealed.

### Experimental Procedure

The testing unit is a 6-sided box made of 0.64 cm (0.25 in) PLEXIGLAS®. The inside of the box has been lightly sandblasted or abraded and then painted a solid, flat black. PLEXIGLAS® is manufactured by Arkema, Inc., of Philadelphia, Pa. The exterior dimensions of the box are 20.32 cm×20.32 cm×16.51 cm (8 in×8 in×6.5 in). In the center of the top of the box, a hole is drilled to allow the probe of a SEKONIC® Digilite Model L-318 photography light meter to fit snugly, permitting minimal light leakage, allowing the body of the meter to be supported by the remaining surface of the box top. SEKONIC® Digilite Model L-318 photography light meters are manufactured by Sekonic USA of Elmsford, N.Y. A centered 10.16 cm×10.16 cm (4 in×4 in) square hole is cut in the bottom of the box. Small tabs or painted strips are placed on the vertical walls of the box at its base to indicate the outer dimensions of the 10.16 cm×10.16 cm (4 in×4 in) hole. These placement guides facilitate the placement of the test unit so that the opening is fully occluded by the sample.

A light box manufactured by Halsey X-Ray Products, Inc., of Brooklyn, N.Y., is turned on and allowed to operate for 900 s (15 min) prior to testing. A 15.24 cm×15.24 cm (6 in×6 in) sheet of opaque material with a central 0.95 cm×4.0 cm (0.38 in×1.56 in) rectangular opening is then centered on the light box. This light blocking template prevents light other than that passing through the glass vial to be evaluated. The glass vial containing the water standard is placed in the rectangular opening in the light blocking template, insuring that the air space in the vial extends to the juncture of the vial wall and base. Using the placement guides, the testing unit is then placed over the template ensuring the central opening is completely occluded by the template. An exposure value (EV) is then determined for the water standard. To take experimental sample readings, the testing unit is removed so that the glass vial containing the water standard is replaced with a glass vial containing an experimental sample. After the testing unit is replaced, an exposure value for the experimental sample is determined. Values for the water standard may change over time. Experimental sample results are only relative to a water standard tested the same day. Percent opacity of the sample is determined by substitution into the following equation:

Opacity(percent)=100−((Exposure Value Experimental Sample(EV)/Exposure Value Water Standard(EV))×100)

The lower the percent opacity obtained for a given sample, the less the dye in the sample bled. Less dye bleeding is predictive of good wet crocking results from the American Association of Textile Chemists and Colorists (AATCC) test method 8. For example, a sample with 2 percent opacity might have good colorfastness to crocking results while a sample with 20 percent or 40 percent opacity might have poor colorfastness to crocking results. Negative percent opacity values might be observed due to several sources: fibers in the solution, differences in the sample beakers, or bubbles in the solution.

### Example 20

### Pilot Scale Production of Black Dyed Fluff Pulp Market Comminution Sheet Roll

The raw materials used for this pilot scale work included FOLEY FLUFFS® and Buckeye Black dye 3. FOLEY FLUFFS® is a bleached Southern softwood Kraft in the form of a comminution sheet manufactured by an affiliate of Buckeye Technologies Inc., of Memphis, Tenn. FOLEY FLUFFS® brand fibers are fabricated from cellulosic materials, primarily wood pulp from slash pine. Buckeye Black dye 3 is made from NOVOCRON® reactive dyes manufactured by the Textile Effects Division of Huntsman (High Point, N.C.).

The 81.92 cm (32.25 in) fluff pulp comminution sheet was situated at the head of the line. The fluff pulp comminution sheet was dyed according to the details explained in Example 17 with the following exceptions. The amount of dye addition resulted in a total sheet moisture of about 46 percent after the dyed fluff pulp comminution sheet was pressed. The first dryer section was operated between 40 to 65 degrees Celsius. The second dryer section was operated between 90 to 115 degrees Celsius. The third dryer section was operated between 100 to 125 degrees Celsius. This resulted in final sheet moisture of about 12 percent. This black dyed fluff pulp market comminution sheet roll was slit to a series of 10.16 cm (4 in) rolls.

### Example 21

### Handsheets Formed to Optimize Binder and ALBAFIX® ECO Addition

Raw materials for the airlaid handsheets consisted of a black dyed fluff pulp market comminution sheet roll prepared according to the description in example 20, FOLEY FLUFFS®, ALBAFIX® ECO, citric acid, ammonium chloride, as well as 9 percent solids emulsions of either VINNAPAS® EN 1020, OMNABOND™ 2463, DUR-O-SET® Elite PLUS, DUR-O-SET® Elite ULTRA, DUR-O-SET® Elite 22, or DUR-O-SET® 10A. Procedure 2 was followed to convert the fluff pulp market comminution sheet rolls into airlaid handsheet forms simulating production material. For this example, each fluff pulp comminution sheet roll was fed into a hammer mill with a 10.16 cm (4 in) slot to mechanically defibrate the sample prior to handsheet formation. Airlaid handsheets were formed for each experimental condition and pressed to a target thickness of 0.55 mm (0.022 in) for each 60 gsm sample. For each airlaid handsheet sample, 51.6 gsm of the structure was comprised of defibrated fluff pulp market comminution sheet and 8.4 gsm was binder.

In some cases, as outlined in Table 26, a catalyst such as citric acid (C₆H₈O₇) or ammonium chloride (NH₄Cl) was added to the binder formulation. Catalyst addition was based upon the binder emulsion solids content. When catalysts were used, they were added to the binder emulsion and considered to be a component of the emulsion for addition purposes. A catalyst was added to compensate for the elevated pH of the dyed fluff pulp market comminution sheet. For examples 21az, 21b1, and 21bm, the final step of Procedure 2 was modified such that the final 150° C. (302° F.) compression was extended from 60 to 180 seconds.

A dye fastness improver, ALBAFIX® ECO, was also added to some of the dyed airlaid handsheet samples. When ALBAFIX® ECO was used, it was added neat based upon the bone dry dyed fluff pulp market comminution sheet content. The method of ALBAFIX® ECO addition is specified in Table 26. The sequence of ALBAFIX® ECO spray addition was geared to simulate the sequence in which the ALBAFIX® ECO might be added to the current commercial airlaid manufacturing process. It could be added via a manifold applicator to one side of the sheet using a peristaltic pump prior to entering the hammer mill; it could be added at one of the two binder spray stations; also, it could be sprayed after exiting the curing oven prior to winding via a finalization bar over a cooling box.

The finalization bar offered the benefit of allowing the binder cross-linking reaction to proceed to completion prior to ALBAFIX® ECO addition because the two chemistries had compatibility issues. The ALBAFIX® ECO does not need heat to react. So, it can be added after the ovens and still function. The lack of heat does limit the amount of moisture that can be added at the finalization bar because any free water added is not decreased by means other than equilibrium. For this reason, total spray moisture addition at the finalization bar was limited to about 2 to about 6 percent by dyed airlaid handsheet sample weight.

For the binder spray station and finalization bar simulations, ALBAFIX® ECO was applied via PREVAL® sprayer on a vacuum box; it was either mixed with the binder emulsion or sprayed separately from the binder emulsion depending upon the addition location being simulated. For the finalization bar addition simulation, the ALBAFIX® ECO was sprayed on only one side of the sheet. The vacuum box was turned on for all examples except 21w and 21aa. For example 21bd and 21bn, the pH of the ALBAFIX® ECO was decreased to pH 4.6 to help compensate for the elevated pH of the dyed fluff pulp market comminution sheet to see if this would make the ALBAFIX® ECO and binders more compatible.

Procedure 4 was followed to test each dyed airlaid handsheet. The composition of the airlaid handsheets is described in Table 26. The high pressure dye bleed results and tensile results are detailed in Table 27. There is no machine or cross directionality to airlaid handsheet samples. Some samples were so weak that they could not be loaded into the sample clamps on the tensile tester. The results for these weak samples are listed as too weak in Table 27.

TABLE 26
Composition of Airlaid Handsheets Blown to Optimize Binder and
ALBAFIX ® ECO Addition

| | Fluff Pulp | | | | | |
|---|---|---|---|---|---|---|
| | Market | | | | | Percent |
| | Comminution | | | Percent | Location of | ALBAFIX ® |
| | Sheet | | | Catalyst | ALBAFIX ® | ECO |
| Example | Used | Binder | Catalyst | Addition | ECO Addition | Addition |
| 21a | FOLEY | DUR-O-SET ® | none | 0.0 | not applicable | 0.0 |
| | FLUFFS ® | Elite 22 | | | | |
| 21b | FOLEY | OMNABOND ™ | none | 0.0 | not applicable | 0.0 |
| | FLUFFS ® | 2463 | | | | |
| 21c | Example 20 | OMNABOND ™ | none | 0.0 | not applicable | 0.0 |
| | | 2463 | | | | |
| 21d | Example 20 | OMNABOND ™ | C₆H₈O₇ | 1.5 | not applicable | 0.0 |
| | | 2463 | | | | |
| 21e | FOLEY | DUR-O-SET ® | none | 0.0 | not applicable | 0.0 |
| | FLUFFS ® | Elite 22 | | | | |
| 21f | Example 20 | DUR-O-SET ® | none | 0.0 | not applicable | 0.0 |
| | | Elite ULTRA | | | | |
| 21g | Example 20 | DUR-O-SET ® | C₆H₈O₇ | 1.5 | before binder | 3.0 |
| | | Elite ULTRA | | | emulsion on | |
| | | | | | side one of | |
| | | | | | sheet | |
| 21h | Example 20 | DUR-O-SET ® | C₆H₈O₇ | 1.5 | after binder | 3.0 |
| | | Elite ULTRA | | | emulsion on | |
| | | | | | side one of | |
| | | | | | sheet | |
| 21i | Example 20 | DUR-O-SET ® | C₆H₈O₇ | 1.5 | mixed with | 3.0 |
| | | Elite ULTRA | | | binder emulsion | |
| | | | | | on side one of | |
| | | | | | sheet | |
| 21j | Example 20 | DUR-O-SET ® | C₆H₈O₇ | 1.5 | before binder | 3.0 |
| | | Elite ULTRA | | | emulsion on | |
| | | | | | side two of | |
| | | | | | sheet | |
| 21k | Example 20 | DUR-O-SET ® | C₆H₈O₇ | 1.5 | mixed with | 3.0 |
| | | Elite ULTRA | | | binder emulsion | |
| | | | | | side two of | |
| | | | | | sheet | |
| 21l | Example 20 | DUR-O-SET ® | C₆H₈O₇ | 1.5 | before binder | 3.0 |
| | | Elite ULTRA | | | emulsion to | |
| | | | | | both sides of | |
| | | | | | sheet | |
| 21m | Example 20 | DUR-O-SET ® | C₆H₈O₇ | 1.5 | mixed with | 3.0 |
| | | Elite ULTRA | | | binder emulsion | |
| | | | | | on both sides of | |
| | | | | | sheet | |
| 21n | FOLEY | DUR-O-SET ® | none | 0.0 | not applicable | 0.0 |
| | FLUFFS ® | Elite 22 | | | | |
| 21o | Example 20 | DUR-O-SET ® | none | 0.0 | pre-hammer | 3.0 |
| | | Elite ULTRA | | | mill application | |
| 21p | Example 20 | DUR-O-SET ® | C₆H₈O₇ | 1.5 | pre-hammer | 3.0 |
| | | Elite ULTRA | | | mill application | |
| 21q | Example 20 | OMNABOND ™ | C₆H₈O₇ | 1.5 | pre-hammer | 3.0 |
| | | 2463 | | | mill application | |
| 21r | Example 20 | DUR-O-SET ® | C₆H₈O₇ | 1.5 | after binder | 3.0 |
| | | Elite ULTRA | | | emulsion on | |
| | | | | | side one of | |
| | | | | | sheet | |
| 21s | Example 20 | OMNABOND ™ | C₆H₈O₇ | 1.5 | after binder | 3.0 |
| | | 2463 | | | emulsion on | |
| | | | | | side one of | |
| | | | | | sheet | |
| 21t | FOLEY | DUR-O-SET ® | none | 0.0 | not applicable | 0.0 |
| | FLUFFS ® | Elite 22 | | | | |
| 21u | Example 20 | DUR-O-SET ® | C₆H₈O₇ | 1.5 | not applicable | 0.0 |
| | | Elite 22 | | | | |
| 21v | Example 20 | DUR-O-SET ® | C₆H₈O₇ | 1.5 | finalization bar | 3.0 |
| | | Elite 22 | | | application | |
| 21w | Example 20 | DUR-O-SET ® | C₆H₈O₇ | 1.5 | finalization bar | 3.0 |
| | | Elite 22 | | | application | |
| 21x | FOLEY | DUR-O-SET ® | none | 0.0 | not applicable | 0.0 |
| | FLUFFS ® | Elite 22 | | | | |
| 21y | Example 20 | DUR-O-SET ® | C₆H₈O₇ | 1.5 | not applicable | 0.0 |
| | | Elite 22 | | | | |
| 21z | Example 20 | DUR-O-SET ® | C₆H₈O₇ | 1.5 | finalization bar | 3.0 |
| | | Elite 22 | | | application | |
| 21aa | Example 20 | DUR-O-SET ® | C₆H₈O₇ | 1.5 | finalization bar | 3.0 |
| | | Elite 22 | | | application | |
| 21ab | Example 20 | DUR-O-SET ® | C₆H₈O₇ | 1.5 | finalization bar | 3.0 |
| | | Elite ULTRA | | | application | |
| 21ac | Example 20 | OMNABOND ™ | C₆H₈O₇ | 1.5 | finalization bar | 3.0 |
| | | 2463 | | | application | |
| 21ad | Example 20 | DUR-O-SET ® | C₆H₈O₇ | 1.5 | finalization bar | 3.5 |
| | | Elite 22 | | | application | |
| 21ae | FOLEY | DUR-O-SET ® | none | 0.0 | not applicable | 0.0 |
| | FLUFFS ® | Elite 22 | | | | |
| 21af | FOLEY | VINNAPAS ® | none | 0.0 | not applicable | 0.0 |
| | FLUFFS ® | EN 1020 | | | | |
| 21ag | Example 20 | DUR-O-SET ® | none | 0.0 | not applicable | 0.0 |
| | | 10A | | | | |
| 21ah | Example 20 | DUR-O-SET ® | C₆H₈O₇ | 1.5 | not applicable | 0.0 |
| | | 10A | | | | |
| 21ai | Example 20 | DUR-O-SET ® | NH₄Cl | 1.5 | not applicable | 0.0 |
| | | 10A | | | | |
| 21aj | Example 20 | VINNAPAS ® | C₆H₈O₇ | 0.0 | not applicable | 0.0 |
| | | EN 1020 | | | | |
| 21ak | Example 20 | VINNAPAS ® | NH₄Cl | 1.5 | not applicable | 0.0 |
| | | EN 1020 | | | | |
| 21al | Example 20 | VINNAPAS ® | C₆H₈O₇ | 1.5 | not applicable | 0.0 |
| | | EN 1020 | | | | |
| 21am | Example 20 | DUR-O-SET ® | NH₄Cl | 0.0 | not applicable | 0.0 |
| | | Elite PLUS | | | | |
| 21an | Example 20 | DUR-O-SET ® | C₆H₈O₇ | 1.5 | not applicable | 0.0 |
| | | Elite PLUS | | | | |
| 21ao | Example 20 | DUR-O-SET ® | NH₄Cl | 1.5 | not applicable | 0.0 |
| | | Elite PLUS | | | | |
| 21ap | FOLEY | DUR-O-SET ® | none | 0.0 | not applicable | 0.0 |
| | FLUFFS ® | Elite 22 | | | | |
| 21aq | FOLEY | VINNAPAS ® | none | 0.0 | not applicable | 0.0 |
| | FLUFFS ® | EN 1020 | | | | |
| 21ar | Example 20 | DUR-O-SET ® | none | 0.0 | not applicable | 0.0 |
| | | 10A | | | | |
| 21as | Example 20 | DUR-O-SET ® | C₆H₈O₇ | 1.5 | finalization bar | 3.0 |
| | | 10A | | | application | |
| 21at | Example 20 | DUR-O-SET ® | C₆H₈O₇ | 2.0 | not applicable | 0.0 |
| | | 10A | | | | |
| 21au | Example 20 | DUR-O-SET ® | C₆H₈O₇ | 1.5 | mixed with | 3.0 |
| | | 10A | | | binder emulsion | |
| | | | | | on both sides of | |
| | | | | | sheet | |
| 21av | Example 20 | DUR-O-SET ® | C₆H₈O₇ | 1.5 | after binder | 3.0 |
| | | 10A | | | emulsion on | |
| | | | | | both sides of | |
| | | | | | sheet | |
| 21aw | FOLEY | DUR-O-SET ® | none | 0.0 | not applicable | 0.0 |
| | FLUFFS ® | Elite 22 | | | | |
| 21ax | FOLEY | VINNAPAS ® | none | 0.0 | not applicable | 0.0 |
| | FLUFFS ® | EN 1020 | | | | |
| 21ay | FOLEY | DUR-O-SET ® | none | 0.0 | not applicable | 0.0 |
| | FLUFFS ® | 10A | | | | |
| 21az | Example 20 | DUR-O-SET ® | C₆H₈O₇ | 1.5 | finalization bar | 3.0 |
| | | 10A | | | application | |
| 21ba | Example 20 | DUR-O-SET ® | C₆H₈O₇ | 1.5 | finalization bar | 3.0 |
| | | 10A | | | application | |
| 21bb | Example 20 | DUR-O-SET ® | C₆H₈O₇ | 3.0 | finalization bar | 3.0 |
| | | 10A | | | application | |
| 21bc | Example 20 | DUR-O-SET ® | C₆H₈O₇ | 3.0 | finalization bar | 3.0 |
| | | Elite ULTRA | | | application | |
| 21bd | Example 20 | DUR-O-SET ® | C₆H₈O₇ | 1.5 | mixed with | 3.0 |
| | | 10A | | | binder emulsion | |
| | | | | | on both sides of | |
| | | | | | sheet | |
| 21be | Example 20 | DUR-O-SET ® | C₆H₈O₇ | 1.5 | finalization bar | 1.0 |
| | | 10A | | | application | |
| 21bf | Example 20 | DUR-O-SET ® | C₆H₈O₇ | 1.5 | finalization bar | 2.0 |
| | | 10A | | | application | |
| 21bg | Example 20 | DUR-O-SET ® | C₆H₈O₇ | 1.5 | finalization bar | 3.0 |
| | | Elite 22 | | | application | |
| 21bh | FOLEY | DUR-O-SET ® | none | 0.0 | not applicable | 0.0 |
| | FLUFFS ® | Elite 22 | | | | |
| 21bi | FOLEY | DUR-O-SET ® | none | 0.0 | not applicable | 0.0 |
| | FLUFFS ® | Elite ULTRA | | | | |
| 21bj | Example 20 | DUR-O-SET ® | C₆H₈O₇ | 1.5 | finalization bar | 3.0 |
| | | Elite ULTRA | | | application | |
| 21bk | Example 20 | DUR-O-SET ® | C₆H₈O₇ | 3.0 | finalization bar | 3.0 |
| | | Elite ULTRA | | | application | |
| 21bl | Example 20 | DUR-O-SET ® | C₆H₈O₇ | 1.5 | finalization bar | 3.0 |
| | | Elite ULTRA | | | application | |
| 21bm | Example 20 | DUR-O-SET ® | C₆H₈O₇ | 3.0 | finalization bar | 3.0 |
| | | Elite ULTRA | | | application | |
| 21bn | Example 20 | DUR-O-SET ® | C₆H₈O₇ | 1.5 | after binder | 3.0 |
| | | Elite ULTRA | | | emulsion on | |
| | | | | | both sides of | |
| | | | | | sheet | |

TABLE 27
High Pressure Dye Bleed and Tensile Results

| | Percent | Dry Tensile | |
|---|---|---|---|
| | Opacity Airlaid | [grams/cm | Wet Tensile [grams/cm |
| Example | Sample | (grams/in)] | (grams/in)] |
| 21a | not applicable | 68 (172) | 22 (56) |
| 21b | not applicable | 44 (112) | 15 (37) |
| 21c | 48.3 | 36 (92) | too weak |
| 21d | 41.4 | 32 (81) | 17 (43) |
| 21e | not applicable | 76 (193) | 32 (82) |
| 21f | 37.9 | 47 (119) | 12 (31) |
| 21g | 3.5 | 52 (131) | 17 (44) |
| 21h | 3.5 | 85 (217) | 21 (53) |
| 21i | 0.0 | 65 (165) | 5 (12) |
| 21j | 0.0 | 55 (140) | 14 (35) |
| 21k | 0.0 | 117 (298) | 15 (37) |
| 21l | 0.0 | 67 (170) | too weak |
| 21m | 0.0 | 73 (186) | too weak |
| 21n | not applicable | 105 (267) | 31 (80) |
| 21o | 6.9 | 74 (187) | 7 (17) |
| 21p | 3.5 | 77 (196) | 9 (22) |
| 21q | 3.5 | 48 (122) | 9 (24) |
| 21r | 10.3 | 75 (190) | 12 (30) |
| 21s | 17.2 | 44 (111) | 8 (20) |
| 21t | not applicable | 81 (205) | 32 (82) |
| 21u | 34.5 | 77 (194) | 19 (49) |
| 21v | 10.3 | 77 (196) | 20 (51) |
| 21w | 3.5 | 54 (138) | 17 (42) |
| 21x | not applicable | 90 (228) | 31 (78) |
| 21y | 35.7 | 68 (173) | 17 (43) |
| 21z | 10.7 | 83 (211) | 13 (32) |
| 21aa | 3.6 | 53 (134) | 18 (46) |
| 21ab | 7.1 | 104 (263) | 19 (49) |
| 21ac | 3.6 | 48 (121) | 12 (30) |
| 21ad | 10.7 | 54 (138) | 16 (41) |
| 21ae | not applicable | 83 (210) | 31 (80) |
| 21af | not applicable | 74 (187) | 36 (91) |
| 21ag | not applicable | 51 (129) | 12 (30) |
| 21ah | not applicable | 52 (131) | 25 (64) |
| 21ai | not applicable | 56 (143) | 17 (44) |
| 21aj | not applicable | 37 (93) | too week |
| 21ak | not applicable | 43 (109) | 16 (41) |
| 21al | not applicable | 37 (94) | 13 (32) |
| 21am | not applicable | 65 (165) | 12 (31) |
| 21an | not applicable | 60 (152) | 17 (43) |
| 21ao | not applicable | 59 (150) | too weak |
| 21ap | not applicable | 56 (141) | 20 (52) |
| 21aq | not applicable | 63 (159) | 35 (88) |
| 21ar | 37.0 | 56 (142) | 20 (51) |
| 21as | 7.4 | 80 (203) | 23 (58) |
| 21at | 37.0 | 77 (196) | 24 (62) |
| 21au | 7.4 | 73 (185) | too weak |
| 21av | 3.7 | 69 (175) | too weak |
| 21aw | not applicable | 99 (252) | 56 (141) |
| 21ax | not applicable | 100 (254) | 43 (110) |
| 21ay | not applicable | 95 (241) | 58 (148) |
| 21az | 18.5 | 102 (258) | 31 (78) |
| 21ba | 11.1 | 102 (258) | 28 (71) |
| 21bb | 7.4 | 117 (296) | 38 (96) |
| 21bc | 14.8 | 65 (165) | 19 (49) |
| 21bd | 7.4 | 93 (235) | 13 (33) |
| 21be | 7.4 | 75 (191) | 28 (71) |
| 21bf | 14.8 | 98 (249) | 17 (42) |
| 21bg | 14.8 | 51 (130) | 19 (47) |
| 21bh | not applicable | 84 (214) | 43 (108) |
| 21bi | not applicable | 177 (449) | 59 (150) |
| 21bj | 14.3 | 130 (329) | 39 (98) |
| 21bk | 3.6 | 140 (356) | 31 (79) |
| 21bl | 10.7 | 156 (397) | 50 (126) |
| 21bm | 7.1 | 163 (415) | 59 (151) |
| 21bn | 32.1 | 227 (577) | too weak |

The addition of an elevated pH reactive dye to a comminution fluff pulp market sheet by the means described in this application resulted in a decrease in binder emulsion cross-link formation as demonstrated by the poor wet tensile values. In some cases, even dry tensile was negatively impacted. Optimization of the binder addition in conjunction with addition of a catalyst resulted in acceptable wet and dry tensile values.

Due to the necessity of obtaining an acceptable value for dyed samples evaluated by Procedure 4, the addition of ALBAFIX® ECO, a dye fastness improver, was necessary. This ALBAFIX® ECO tied up most of the remaining quantity of excess dye so that it was expressed only minimally via Procedure 4. However, even for dyed airlaid handsheet samples to which binder was optimized and 3.0 percent catalyst was added, poor tensile values were obtained when a ALBAFIX® ECO was introduced prior to binder cross-link formation. When ALBAFIX® ECO was applied after binder cross-link formation, by means of a finalization bar, acceptable wet and dry tensile values were obtained.

### Example 22

### Evaluation of Polycup™ 920A Resin with Latex Binders for Increase in Wet Tensile Strength

The raw materials consisted of FOLEY FLUFFS®, DUR-O-SET® Elite 22, DUR-β-SET® ELITE ULTRA, Polycup™ 920A, and a dyed fluff pulp market comminution sheet roll prepared according to the description in example 20. Procedure 2 was followed in order to convert the fluff pulp market comminution sheet rolls into airlaid handsheet forms simulating production material. These airlaid handsheets were pressed to a target thickness of 0.55 mm (0.022 in) for each approximately 60 gsm sample. For each airlaid handsheet sample, about 51.6 gsm of the structure was comprised of the defibrated fluff pulp comminution sheet and about 8.4 gsm was binder.

The first portion of this example concerns the effect that Polycup™ 920A wet strength resin has on the wet tensile strength of a dyed airlaid handsheet and dye bleed. The control for this study was an airlaid handsheet made from FOLEY FLUFFS® and a DUR-O-SET® Elite 22 binder emulsion applied at about 8.4 gsm. The experimental examples were sprayed either with DUR-O-SET® Elite ULTRA alone, DUR-O-SET® Elite ULTRA mixed in with Polycup™ 920A, or DUR-O-SET® Elite ULTRA sprayed separately from Polycup™ 920A for a total of about 14 percent by dry weight addition. The two chemicals were sprayed separately in order to determine if there was a difference in tensile strength as opposed to the mixture. The composition of the airlaid handsheet samples is described in Table 28. Procedure 4 was followed to test each dyed airlaid handsheet. The high pressure dye bleed and tensile results are included in Table 29.

TABLE 28
Composition of Handsheets Blown to Simulate Pilot Plant Conditions

| | Fluff Pulp | | Latex | | |
|---|---|---|---|---|---|
| | Market | Binder | Binder | | Total Binder |
| | Comminution | Formulation | Component | Polycup ™ | Addition |
| Example | Sheet Used | Components | (gsm) | 920A (gsm) | (gsm) |
| 22a | FOLEY | Latex binder | 8.4 | 0.0 | 8.4 |
| | FLUFFS ® | only | | | |
| 22b | Example 20 | Latex binder | 8.4 | 0.0 | 8.4 |
| | | only | | | |
| 22c | Example 20 | Sprayed | 5.4 | 2.2 | 7.6 |
| | | Separately | | | |
| 22d | Example 20 | Mixture | 5.4 | 2.2 | 7.6 |
| 22e | Example 20 | Mixture | 5.4 | 2.2 | 7.6 |

TABLE 29
High Pressure Dye Bleed and Tensile Results for Airlaid Handsheets

| | | Dry Tensile | Wet Tensile |
|---|---|---|---|
| | Percent Opacity | [grams/cm | [grams/cm |
| Example | Airlaid Sample | (grams/in)] | (grams/in)] |
| 22a | 2.6 | 119 (47) | 60 (24) |
| 22b | 46.0 | 280 (110) | 55 (22) |
| 22c | 0.0 | 146 (57) | 32 (13) |
| 22d | 0.0 | 384 (151) | 77 (30) |
| 22e | 0.0 | 260 (102) | 98 (39) |

By creating a mixture that contains both latex binder and Polycup™ 920A, the wet tensile strength of a dyed airlaid handsheet sample can be significantly increased over latex binder alone. It was also observed that by adding Polycup™ 920A to the binder emulsion there was no dye bleed. Polycup™ 920A wet strength resin causes an increase in tensile strength and acts as a dye fixative.

After discovering that the addition of Polycup™ 920A to a latex binder increased the wet tensile strength of dyed airlaid handsheets and stopped excess dye bleed, an optimum addition level that would maintain acceptable wet tensile strength was determined. Additional dyed airlaid handsheet samples were blown for comparison with the control sample 22a. These dyed airlaid handsheets, produced according to procedure 2, were pressed to a target thickness of 0.55 mm (0.022 in) for each approximately 60 gsm sample. The composition of the dyed airlaid handsheet samples is described in Table 30. Procedure 4 was followed to test each handsheet. The high pressure dye bleed and tensile results are included in Table 31.

TABLE 30
Composition of Handsheets Blown to Simulate Pilot Plant Conditions

| | Fluff Pulp | | | | |
|---|---|---|---|---|---|
| | Market | | | Latex Binder | |
| | Comminution | | Polycup ™ | Component | Total Binder |
| Example | Sheet (gsm) | Binder pH | 920A (gsm) | (gsm) | Addition (gsm) |
| 22a | 51.6 | Less than 4 | 0.0 | 8.4 | 8.4 |
| 22f | 54.0 | Less than 3 | 1.5 | 3.9 | 5.4 |
| 22g | 51.6 | Less than 3 | 2.2 | 5.4 | 7.6 |
| 22h | 51.6 | Less than 3 | 1.5 | 6.3 | 7.8 |
| 22i | 51.6 | Less than 3 | 2.0 | 5.6 | 7.6 |
| 22j | 51.6 | 6.0 | 2.0 | 5.6 | 7.6 |

TABLE 31
High Pressure Dye Bleed and Tensile Results for Airlaid Handsheets

| | Percent | Dry Tensile | Wet Tensile |
|---|---|---|---|
| | Opacity Airlaid | [grams/cm | [grams/cm |
| Example | Sample | (grams/in)] | (grams/in)] |
| 22a | 2.5 | 119 (47) | 60 (24) |
| 22f | 0.0 | 154 (61) | 59 (23) |
| 22g | 0.0 | 208 (82) | 68 (27) |
| 22h | 0.0 | 256 (101) | 67 (26) |
| 22i | 0.0 | 156 (61) | 46 (18) |
| 22j | 0.0 | 143 (56) | 52 (20) |

When the binder addition represented about 14 percent (8.4 gsm) or more of the total dyed airlaid handsheet structure there was an increase in the wet tensile strength. If about 14 percent (8.4 gsm) or more addition to the dyed airlaid handsheet was maintained, the addition of Polycup™ 920A could be reduced and still maintain the higher wet tensile strength as well as stop excess dye bleed. Once the amount of latex within the binder emulsion was reduced, the wet tensile strength of the dyed airlaid handsheet was significantly reduced. It was observed that by adjusting the pH of the binder emulsion to a pH range recommended for use of Polycup™ 920A there was no significant difference in the wet tensile strength of the dyed airlaid handsheets.

In this example, when a wet strength resin such as Polycup™ 920A was added to a latex binder emulsion, it greatly increased the wet tensile strength and improved dye fixation for the dyed airlaid handsheet sample.

### Example 23

### Pilot Scale Dyed Nonwoven Sample Experimental Trial

In addition to the airlaid handsheet examples, a dyed airlaid substrate was prepared on a DannWeb pilot scale airlaid manufacturing unit at Buckeye Technologies Inc. in Memphis, Tenn. The raw materials used for this pilot scale work included a black dyed fluff pulp market comminution sheet roll prepared according to the description in example 20, FOLEY FLUFFS®, DUR-O-SET® Elite ULTRA, DUR-O-SET® Elite 22, DUR-O-SET® 10A, Polycup™ 920A, ALBAFIX® ECO, and citric acid.

The first forming head added about 51.6 gsm of the particular defibrated fluff pulp comminution sheet roll being used. Immediately after this, the web was compacted via the compaction roll set at 400 to 700 kPa. Then, binder was sprayed onto the top of the web. The web was cured in a Moldow Through Air Tunnel Dryer at a temperature of 165° C. After this, the web was wound and collected. The web was re-oriented at the front of the line so that additional binder could be applied to the opposite side of the web. Then, the web was cured in a Moldow Through Air Tunnel Dryer at a temperature of 165° C. The machine speed was approximately 30 meters/min. Finally, the web was re-oriented at the front of the line so that the finalization bar could be simulated. The web was run through a Moldow Through Air Tunnel Dryer at a temperature of 175° C. and a machine speed of approximately 60 meters/min. An additional spray bar, termed a finalization bar as explained in Example 21, was situated just after the dryer over the cooling box to apply fixative where applicable. When fixative was not added, water was sprayed to limit experimental variation.

In some cases, as outlined in Table 32, a catalyst such as citric acid (C₆H₈O₇) was added to the binder formulation. Three percent catalyst addition was based upon the binder emulsion solids content. When the catalyst was used, it was added to the binder emulsion and considered to be a component of the emulsion for addition purposes. Catalyst was added to compensate for the elevated pH of the dyed fluff pulp market comminution sheet.

A dye fastness improver, ALBAFIX® ECO, was also added to some of the airlaid handsheet samples. When ALBAFIX® ECO was used; it was added neat based upon the bone dry dyed fluff pulp market comminution sheet content.

For samples containing Polycup™ 920A additions, the Polycup™ 920A was mixed directly into the binder emulsion.

The composition of the airlaid substrates is described in Tables 32 and 33. Procedure 4 was followed to test each handsheet. The high pressure dye bleed, caliper, and tensile results are included in Table 36.

TABLE 32
Composition of Airlaid Substrate Pilot Plant Conditions

| | Fluff Pulp | | | | |
|---|---|---|---|---|---|
| | Market | | Binder | Percent | Fixative |
| | Comminution | | Addition | C₆H₈O₇ | Addition |
| Example | Sheet Used | Binder Used | (gsm) | Addition | (gsm) |
| 23a | FOLEY | DUR-O-SET ® | 14 | 0.0 | 0.0 |
| | FLUFFS ® | Elite 22 | | | |
| 23b | FOLEY | DUR-O-SET ® | 10 | 0.0 | 0.0 |
| | FLUFFS ® | Elite 22 | | | |
| 23c | FOLEY | DUR-O-SET ® | 14 | 0.0 | 0.0 |
| | FLUFFS ® | Elite 22 | | | |
| 23d | Example 20 | DUR-O-SET ® | 14 | 3.0 | 1.46 |
| | | Elite 22 | | | |
| 23e | Example 20 | DUR-O-SET ® | 14 | 3.0 | 1.46 |
| | | 10A | | | |
| 23f | Example 20 | DUR-O-SET ® | 14 | 3.0 | 0.73 |
| | | 10A | | | |
| 23g | Example 20 | DUR-O-SET ® | 10 | 3.0 | 1.46 |
| | | 10A | | | |
| 23h | Example 20 | DUR-O-SET ® | 14 | 3.0 | 1.46 |
| | | Elite ULTRA | | | |
| 23i | Example 20 | DUR-O-SET ® | 14 | 3.0 | 0.73 |
| | | Elite ULTRA | | | |
| 23j | Example 20 | DUR-O-SET ® | 10 | 3.0 | 1.46 |
| | | Elite ULTRA | | | |

TABLE 33
Composition of Airlaid Substrate Pilot Plant Conditions

| | Fluff Pulp | | | Polycup ™ | Total Binder |
|---|---|---|---|---|---|
| | Comminution | | Binder | 920A | Addition |
| Example | Sheet Used | Binder Used | (gsm) | (gsm) | (gsm) |
| 23k | Example 20 | DUR-O-SET ® | 5.4 | 2.2 | 7.6 |
| | | Elite ULTRA | | | |
| 23l | Example 20 | DUR-O-SET ® | 6.3 | 1.5 | 7.8 |
| | | Elite ULTRA | | | |
| 23m | Example 20 | DUR-O-SET ® | 5.4 | 2.2 | 7.6 |
| | | 10A | | | |
| 23n | Example 20 | DUR-O-SET ® | 6.3 | 1.5 | 7.8 |
| | | 10A | | | |

TABLE 34
High Pressure Dye Bleed and Tensile Results for Airlaid Substrates

| | | | Machine | Cross | Cross |
|---|---|---|---|---|---|
| | | | Direction | Direction | Direction |
| | Percent | | Dry | Dry | Wet |
| | Opacity | | Tensile | Tensile | Tensile |
| Exam- | Airlaid | Caliper | [grams/cm | [grams/cm | [grams/cm |
| ple | Sample | (mm) | (grams/in)] | (grams/in)] | (grams/in)] |
| 23a | not | 0.64 | 363 (923) | 307 (779) | 180 (456) |
| | applicable | | | | |
| 23b | not | 0.64 | 462 (1174) | 322 (817) | 233 (592) |
| | applicable | | | | |
| 23c | not | 0.96 | 280 (710) | 220 (558) | 135 (343) |
| | applicable | | | | |
| 23d | 8.3 | 1.03 | 229 (581) | 138 (350) | 69 (175) |
| 23e | 16.7 | 0.96 | 161 (409) | 112 (284) | 70 (179) |
| 23f | 12.5 | 1.02 | 209 (531) | 145 (368) | 78 (197) |
| 23g | 16.7 | 1.09 | 183 (465) | 74 (189) | 52 (132) |
| 23h | 8.3 | 1.13 | 244 (619) | 141 (358) | 62 (157) |
| 23i | 0.0 | 1.05 | 307 (779) | 139 (353) | 50 (128) |
| 23j | 12.5 | 1.06 | 191 (485) | 102 (258) | 50 (128) |
| 23k | 0.0 | 0.75 | 268 (681) | 152 (386) | 76 (194) |
| 23l | 0.0 | 0.70 | 169 (428) | 120 (305) | 56 (141) |
| 23m | 0.0 | 0.70 | 199 (506) | 125 (317) | 50 (127) |
| 23n | 0.0 | 0.69 | 157 (400) | 142 (361) | 63 (159) |

From the pilot substrate evaluations, it was observed that ALBAFIX® ECO added by a finalization bar and Polycup™ 920A resin added to a binder both minimize or completely eliminate dye bleed. Also, several samples maintained at least 50 percent of the cross directional wet tensile as compared to the FOLEY FLUFFS® control samples. This demonstrated that it is possible to improve both dye fastness and wet tensile for airlaid dyed fluff pulp market comminution sheet substrates by either adding a wet strength resin such as Polycup™ 920A to the binder or by adding a catalyst to the binder as well as a dye fixative such as ALBAFIX® ECO using a finalization bar.

### Example 24

### Colorfastness to Crocking Test Results

Various examples were evaluated by Procedure 3. The standard test was modified for these examples by reducing the number of turns from 10 as noted in the table due to the tendency of some of the samples to tear during testing. An AATCC Chromatic Transference Scale was used to determine the Grade Classifications.

TABLE 35
Wet and Dry Colorfastness to Crocking Results

| | | | Dry Rub | Wet Rub |
|---|---|---|---|---|
| | | Number | Grade | Grade |
| Example | Example Description | of Turns | Classification | Classification |
| 18a | Airlaid handsheets made from | 10 dry, 4 | 5.0 | 3.5 |
| | Roll 17a Black dyed fluff pulp | wet | | |
| | market comminution sheet | | | |
| 18b | Airlaid handsheets made from | 10 dry, 4 | 5.0 | 3.0 |
| | Roll 17b Black dyed fluff pulp | wet | | |
| | market comminution sheet | | | |
| 18c | Airlaid handsheets made from | 10 dry, 4 | 5.0 | 3.0 |
| | Roll 17c Black dyed fluff pulp | wet | | |
| | market comminution sheet | | | |
| 18d | Airlaid handsheets made from | 10 dry, 4 | 5.0 | 3.0 |
| | Roll 17d Black dyed fluff pulp | wet | | |
| | market comminution sheet | | | |
| 24a | WALKISOFT ® Black 181 | 10 dry, 4 | 4.5 | 1.0 |
| | | wet | | |
| 18e | Airlaid handsheets made from | 10 dry, 4 | 5.0 | 3.5 |
| | Roll 17e Burgundy dyed fluff | wet | | |
| | pulp market comminution sheet | | | |
| 18f | Airlaid handsheets made from | 10 dry, 4 | 5.0 | 3.0 |
| | Roll 17f Burgundy dyed fluff | wet | | |
| | pulp market comminution sheet | | | |
| 18g | Airlaid handsheets made from | 10 dry, 4 | 5.0 | 3.0 |
| | Roll 17g Burgundy dyed fluff | wet | | |
| | pulp market comminution sheet | | | |
| 18h | Airlaid handsheets made from | 10 dry, 4 | 5.0 | 3.5 |
| | Roll 17h Burgundy dyed fluff | wet | | |
| | pulp market comminution sheet | | | |
| 24b | WALKISOFT ® Burgundy 120 | 10 dry, 4 | 4.5 | 2.0 |
| | | wet | | |
| 19a | Commercially produced Black | 10 dry, | 4.5 | 2.5 |
| | 60 gsm dyed nonwoven substrate | 10 wet | | |
| 19b | Commercially produced Black | 10 dry, | 4.5 | 2.5 |
| | 52 gsm dyed nonwoven substrate | 10 wet | | |
| 19c | Commercially produced | 10 dry, | 4.5 | 2.5 |
| | Burgundy 60 gsm dyed | 10 wet | | |
| | nonwoven substrate | | | |
| 19d | Commercially produced | 10 dry, | 4.5 | 2.5 |
| | Burgundy 52 gsm dyed | 10 wet | | |
| | nonwoven substrate | | | |
| 24c | WALKISOFT ® Black 181 | 10 dry, | 4.5 | 1.5 |
| | | 10 wet | | |
| 24d | WALKISOFT ® Burgundy 120 | 10 dry, | 4.5 | 2.0 |
| | | 10 wet | | |

All patents, patent applications, publications, product descriptions and protocols, cited in this specification are hereby incorporated by reference in their entirety. In case of a conflict in terminology, the present disclosure controls.

While it will be apparent that the invention herein described is well calculated to achieve the benefits and advantages set forth above, the present invention is not to be limited in scope by the specific embodiments described herein. It will be appreciated that the invention is susceptible to modification, variation and change without departing from the spirit thereof. For instance, the nonwoven structure is described in the context of an airlaid process. However, non-airlaid processes are also contemplated.

What is claimed is:

1. A dyed cellulose comminution sheet comprising:
(a) a cellulose pulp comminution sheet having a cellulose content of from about 60 weight percent to about 99.9 weight percent cellulose based on the total weight of solids in the cellulose pulp comminution sheet, and a density of from about 0.3 g/cm³ to about 0.95 g/cm³;
(b) a moisture content of from about 25 weight percent to about 55 weight percent, based on the total weight of the dyed cellulose comminution sheet, wherein the moisture content does not exceed bleed point of the comminution sheet; and
(c) a dye.

2. The dyed cellulose comminution sheet of claim 1, wherein the sheet has a moisture content of from about 35 weight percent to about 48 weight percent, based on the total weight of the dyed cellulose comminution sheet.

3. The dyed cellulose comminution sheet of claim 1, wherein the cellulose pulp comprises wood cellulose pulp, cotton linter pulp, chemically modified cellulose, bleached pulp, thermomechanical fibers, matrix fibers, or a combination thereof.

4. The dyed cellulose comminution sheet of claim 1, wherein the density of the cellulose pulp comminution sheet is from about 0.4 g/cm³ to about 0.75 g/cm³.

5. The dyed cellulose comminution sheet of claim 1, wherein the dye is a direct dye, a reactive dye or a mixture thereof.

6. The dyed cellulose comminution sheet of claim 5, wherein the dye is a direct dye.

7. The dyed cellulose comminution sheet of claim 5, wherein the dye is a reactive dye.

8. A dyed cellulose market comminution sheet with a moisture content of from about 5 weight percent to about 10 weight percent, based on the total weight of the dyed cellulose market comminution sheet, wherein the dyed cellulose market comminution sheet does not bleed, and wherein the dyed cellulose market comminution sheet has been produced by drying the dyed cellulose comminution sheet of claim 1.

9. A process for the production of a dyed cellulose market comminution sheet comprising:
(a) a cellulose pulp comminution sheet having a cellulose content of from about 60 weight percent to about 99.9 weight percent cellulose based on the total weight of the cellulose pulp sheet, and a density of from about 0.3 g/cm³ to about 0.7 g/cm³,
(b) a moisture content of from about 5 weight percent to about 10 weight percent, based on the total weight of the dyed cellulose comminution sheet, and
(c) a dye;
where the steps of the process comprise:
(i) optionally, adjusting the moisture content of a cellulose pulp comminution sheet with an initial moisture content of from about 2 weight percent to about 12 weight percent to a moisture content in the range of from about 6 weight percent to about 40 weight percent, where the weight percentages are based on the total weight of the cellulose comminution sheet,
(ii) contacting the cellulose pulp comminution sheet from (i) with aqueous dye to produce a dyed comminution sheet with a moisture content of from about 25 weight percent to about 55 weight percent, where the weight percentages are based on the total weight of the dyed cellulose comminution sheet, wherein the moisture content does not exceed the bleed point,
(iii) applying pressure to the dyed cellulose comminution sheet from (ii) to spread the dye evenly throughout the dyed cellulose comminution sheet, and
(iv) heating the dyed cellulose comminution sheet from (iii) to reduce the moisture content to an amount of from about 5 weight percent to about 10 weight percent to produce a dyed cellulose market comminution sheet, where the weight percentages are based on the total weight of the dyed cellulose market comminution sheet.

10. The process of claim 9, wherein the moisture content of the cellulose pulp comminution sheet is adjusted to a moisture content in the range of from about 15 weight percent to about 40 weight percent, where the weight percentages are based on the total weight of the cellulose comminution sheet

11. The process of claim 9, wherein the applied pressure is from about 400 kg/linear meter to about 3500 kg/linear meter.

12. A dyed cellulose market comminution sheet produced by the process of claim 9.

13. A dyed nonwoven material comprising:
(a) from about 75 weight percent to about 95 weight percent of dyed cellulose fibers from a dyed cellulose market comminution sheet of claim 12,
(b) from about 5 weight percent to about 25 weight percent of latex solids, where the weight percentages are based on the total weight of the dyed nonwoven material, where the dyed nonwoven material has a basis weight of from about 50 gsm to about 120 gsm.

14. The dyed nonwoven material of claim 13, wherein the dyed nonwoven material has a dry rub grade classification as determined by AATCC test method 8 of about 4.2 or greater.

15. The dyed nonwoven material of claim 13, further comprising a wet strength resin.

16. The dyed nonwoven material of claim 15, wherein the wet strength resin is a polyamide epichlorohydrin adduct.

17. A process for the production of a dyed nonwoven comprising:
(a) comminuting a dyed cellulose market comminution sheet of claim 12 to produce individualized dyed fibers,
(b) airlaying the individualized dyed fibers to form a dyed nonwoven material,
(c) treating the dyed nonwoven material from (b) with aqueous latex, and
(d) heating the nonwoven to cure the latex.

18. The process for the production of a dyed nonwoven of claim 17, further comprising:
(e) after heating the nonwoven to cure the latex, adding a dye fixative to the dyed nonwoven material.

19. The process for the production of a dyed nonwoven of claim 17, further comprising:
(f) prior to, during, or after performing step (c), adding to the dyed nonwoven material a binder catalyst.

20. The process for the production of a dyed nonwoven of claim 17, further comprising:
(g) prior to, during, or after performing step (c), adding to the dyed nonwoven material a wet strength resin.

21. The process for the production of a dyed nonwoven of claim 20, wherein the wet strength resin is a polyamide epichlorohydrin adduct.
